(19) United States
(12) Patent Application Publication
(10) Pub. No.: US 2026/0095963 A1
(43) Pub. Date: Apr. 2, 2026

(54) METHOD OF WIRELESS COMMUNICATION AND RELATED APPARATUS

(71) Applicant: GREATER SHINE LIMITED, NEW TAIPEI CITY (TW)

(72) Inventor: Liangxiao XIN, New Taipei City (TW)

(21) Appl. No.: 18/899,796

(22) Filed: Sep. 27, 2024

Related U.S. Application Data
(60) Provisional application No. 63/529,656, filed on Jul. 28, 2023.
(60) Provisional application No. 63/529,663, filed on Jul. 28, 2023.

(51) Int. Cl. H04W 76/12; H04W 8/00

(52) U.S. Cl. CPC H04W 76/12; H04W 8/005

(57) ABSTRACT

A method of wireless communication and related apparatus are provided. The method, by a first non-AP STA, includes establishing, by at least one processor, a communication link with an AP; establishing, by the at least one processor, tunneled direct link setup (TDLS) link with a second non-AP STA; performing, by the at least one processor, peer-to-peer communication with the second non-AP STA during the TDLS link; and in response to at least one communication condition meeting a first condition, communicating, by the at least one processor, with the second non-AP STA via the AP using the communication link. This can solve issues in the prior art, provide a good communication performance, and/or provide high reliability.

### CROSS REFERENCE TO RELATED APPLICATIONS

This application claims priority to U.S. Provisional Applications No. 63/529,656, filed on Jul. 28, 2023 and U.S. Provisional Application No. 63/529,663, filed on Jul. 28, 2023, the contents of which are incorporated by reference in their entirety.

### BACKGROUND OF DISCLOSURE

The present disclosure relates to the field of communication systems, and more particularly, to a method of wireless communication and related apparatus such as a station (STA), an access point (AP), and etc., which can provide a good communication performance and/or high reliability.

Communication systems such as wireless communication systems are widely deployed to provide various types of communication content such as voice, video, packet data, messaging, broadcast, and so on. These communication systems may be multiple-access systems capable of supporting communication with multiple users by sharing available system resources (such as, time, frequency, and power). A wireless network, for example a wireless local area network (WLAN), such as a Wi-Fi (institute of electrical and electronics engineers (IEEE) 802.11) network, may include an access point (AP) that may communicate with one or more stations (STAs) or mobile devices. The WLAN enables a user to wirelessly access an internet based on radio frequency technology in a home, an office, or a specific service area using a portable terminal such as a personal digital assistant (PDA), a laptop computer, a portable multimedia player (PMP), a smartphone, etc. The AP may be coupled to a network, such as the internet, and may enable a mobile device to communicate via the network (or communicate with other devices coupled to the AP). A wireless device may communicate with a network device bi-directionally. For example, in a WLAN, a STA may communicate with an associated AP via downlink and uplink. The downlink may refer to a communication link from the AP to the STA, and the uplink may refer to a communication link from the STA to the AP.

Tunneled Direct Link Setup (TDLS) is a wireless communication protocol that allows devices to establish a direct link for data transmission while remaining connected to a traditional Wi-Fi network. This technology, developed by the Wi-Fi Alliance and based on the IEEE 802.11 standard, enhances the efficiency of data transfer between two devices without the need to route traffic through an AP. How to address relevant problems in TDLS links is important in this field.

### SUMMARY

An object of the present disclosure is to propose a method of wireless communication and related apparatus, which can solve issues in the prior art, provide a good communication performance, and/or provide high reliability.

In a first aspect of the present disclosure, a method of wireless communication of a first non-access point (AP) station (STA) comprises establishing, by at least one processor, a communication link with an AP; establishing, by the at least one processor, tunneled direct link setup (TDLS) link with a second non-AP STA; performing, by the at least one processor, peer-to-peer communication with the second non-AP STA during the TDLS link; and in response to at least one communication condition meeting a first condition, communicating, by the at least one processor, with the second non-AP STA via the AP using the communication link.

In a second aspect of the present disclosure, a method of wireless communication of a first node comprises establishing, by at least one processor, a communication session with a second node while the first node operates as a first-node type; announcing, by the at least one processor, a transition of the first node from the first-node type to a second node-type to the second node; and transitioning, by the at least one processor, from the first-node type to the second-node type.

In a third aspect of the present disclosure, a method of wireless communication of a first node comprises establishing, by at least one processor, a communication session with a second node while the second node operates as a first-node type; receiving, by the at least one processor, an announcement of a transition of the second node from the first-node type to a second-node type from the second node; and keeping, by the at least one processor, the communication session with the second node or establishing, by the at least one processor, another communication session with the second node after the announcement is received.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of a wireless communications system according to an embodiment of the present disclosure.

FIG. 2 is a schematic diagram illustrating an example of a wireless communications system according to another embodiment of the present disclosure.

FIG. 3 is a schematic diagram illustrating an example of a wireless communications system according to another embodiment of the present disclosure.

FIG. 4 is a block diagram showing an example of wireless station hardware according to an embodiment of the present disclosure.

FIG. 5 is a block diagram showing an example of wireless multi-link device hardware according to an embodiment of the present disclosure.

FIG. 6 is a block diagram showing one or more stations (STAs) and an access point (AP) of communication in a wireless communications system according to an embodiment of the present disclosure.

FIG. 7 is a schematic diagram illustrating EtherType 89-0d frame body in accordance with current IEEE 802.11 network.

FIG. 8 is a flowchart of a method of wireless communication of a first non-AP station according to an embodiment of the present disclosure.

FIG. 9 is a schematic diagram illustrating TDLS link and backup link according to an embodiment of the present disclosure.

FIG. 10 is a schematic diagram illustrating switching between TDLS link and backup link according to an embodiment of the present disclosure.

FIG. 11 is a schematic diagram illustrating an example of P2P transmission via backup link in multiple TXOPs according to an embodiment of the present disclosure.

FIG. 12 is a schematic diagram illustrating another example of P2P transmission via backup link in multiple TXOPs according to an embodiment of the present disclosure.

FIG. 13 is a schematic diagram illustrating an example of P2P transmission via backup link in a single TXOP according to an embodiment of the present disclosure.

FIG. 14 is a schematic diagram illustrating another example of P2P transmission via backup link in a single TXOP according to an embodiment of the present disclosure.

FIG. 15 is a schematic diagram illustrating the format of Payload in EtherType 89-0d frame body when payload type is set to TDLS data according to an embodiment of the present disclosure.

FIG. 16 is a schematic diagram illustrating the format of TDLS control field according to an embodiment of the present disclosure.

FIG. 17 is a schematic diagram illustrating the format of Payload in EtherType 89-0d frame body when payload type is set to TDLS BA according to an embodiment of the present disclosure.

FIG. 18 is a flowchart of a method of wireless communication of a first node (e.g., a peer STA transitioning to a soft AP or a soft AP transitioning to a peer STA) according to an embodiment of the present disclosure.

FIG. 19 is a flowchart of a method of wireless communication of a first node (e.g., a peer STA) according to another embodiment of the present disclosure.

FIG. 20 is a schematic diagram illustrating an example of keeping TDLS link when STA2 switches from Peer STA to Soft AP according to an embodiment of the present disclosure.

FIG. 21 is a schematic diagram illustrating an example of reassociation immediately after STA2 changes from Peer STA to Soft AP according to an embodiment of the present disclosure.

FIG. 22 is a schematic diagram illustrating an example of setting up TDLS link after STA2 changes from soft AP to Peer STA according to an embodiment of the present disclosure.

FIG. 23 is a schematic diagram illustrating the format of the fast transition between non-AP and soft AP element according to an embodiment of the present disclosure.

FIG. 24 is a schematic diagram illustrating TDLS Discovery procedure.

FIG. 25 is a schematic diagram illustrating Multi-Link Identifier element format according to an embodiment of the present disclosure.

FIG. 26 is a schematic diagram illustrating the format of the Common Info field of the TDLS Multi-Link element according to an embodiment of the present disclosure.

FIG. 27 is a schematic diagram illustrating Per-Link Info subelement format of the TDLS Multi-Link element according to an embodiment of the present disclosure.

FIG. 28 is a schematic diagram illustrating a first example of TDLS discovery for multiple links according to an embodiment of the present disclosure.

FIG. 29 is a schematic diagram illustrating a second example of TDLS discovery for multiple links according to an embodiment of the present disclosure.

FIG. 30 is a schematic diagram illustrating a third example of TDLS discovery for multiple links according to an embodiment of the present disclosure.

FIG. 31 is a schematic diagram illustrating a fourth example of TDLS discovery for multiple links according to an embodiment of the present disclosure.

FIG. 32 is a schematic diagram illustrating a fifth example of TDLS discovery for multiple links according to an embodiment of the present disclosure.

FIG. 33 is a schematic diagram illustrating NDP Announcement frame format.

FIG. 34 is a schematic diagram illustrating STA Info field format in an EHT NDP Announcement frame.

FIG. 35 is a schematic diagram illustrating trigger frame format.

FIG. 36 is a schematic diagram illustrating EHT variant Common Info field format.

FIG. 37 is a schematic diagram illustrating HE variant User Info field format.

FIG. 38 is a schematic diagram illustrating EHT variant User Info field format in the MU-RTS TXS Trigger frame.

FIG. 39 is a schematic diagram illustrating a trigger dependent User Info subfield format in a BFRP trigger frame.

FIG. 40 is a schematic diagram illustrating a sounding procedure for P2P transmission according to an embodiment of the present disclosure.

FIG. 41 is a schematic diagram illustrating an example of spatial reuse for intra-BSS P2P transmissions according to an embodiment of the present disclosure.

FIG. 42 is a schematic diagram illustrating another example of spatial reuse for intra-BSS P2P transmissions according to an embodiment of the present disclosure.

FIG. 43 is a schematic diagram illustrating an example of assignment of secondary channel for P2P transmission according to an embodiment of the present disclosure.

FIG. 44 is a schematic diagram illustrating UHR NDP Announcement frame format according to an embodiment of the present disclosure.

FIG. 45 is a schematic diagram illustrating STA Info field format in an UHR NDP Announcement frame according to an embodiment of the present disclosure.

FIG. 46 is a schematic diagram illustrating UHR variant User Info field format in the UHR MU-RTS TXS Trigger frame according to an embodiment of the present disclosure.

FIG. 47 is a schematic diagram illustrating STA Info field format in an EHT NDP Announcement frame according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

FIG. 1 illustrates an example of a wireless communications system according to an embodiment of the present disclosure. The wireless communications system may be an example of a wireless local area network (WLAN) 100 (also known as a Wi-Fi network) (such as next generation, next big thing (NBT), ultra-high throughput (UHT) or EHT Wi-Fi network) configured in accordance with various aspects of the present disclosure. As described herein, the terms next generation, NBT, UHT, and EHT may be considered synonymous and may each correspond to a Wi-Fi network supporting a high volume of space-time-streams. The WLAN 100 may include an access point (AP) 10 and multiple associated stations (STAs) 20, which may represent devices such as mobile stations, personal digital assistant (PDAs), other handheld devices, netbooks, notebook computers, tablet computers, laptops, display devices (such as TVs, computer monitors, etc.), printers, etc. The AP 10 and the associated stations 20 may represent a basic service set (BSS) or an extended service set (ESS). The various STAs 20 in the network can communicate with one another through the AP 10. Also illustrated is a coverage area 110 of the AP 10, which may represent a basic service area (BSA) of the WLAN 100. An extended network station (not shown) associated with the WLAN 100 may be connected to a wired or wireless distribution system that may allow multiple APs 10 to be connected in an ESS.

In some embodiments, a STA 20 may be located in the intersection of more than one coverage area 110 and may associate with more than one AP 10. The STA 20 communicates with the AP 10 via a communication line 120. A single AP 10 and an associated set of STAs 20 may be referred to as a BSS. An ESS is a set of connected BSSs. A distribution system (not shown) may be used to connect APs 10 in an ESS. In some cases, the coverage area 110 of an AP 10 may be divided into sectors (also not shown). The WLAN 100 may include APs 10 of different types (such as a metropolitan area, home network, etc.), with varying and overlapping coverage areas 110. Two STAs 20 also may communicate directly via a direct wireless link 125 regardless of whether both STAs 20 are in the same coverage area 110. Examples of direct wireless links 125 may include Wi-Fi direct connections, Wi-Fi tunneled direct link setup (TDLS) links, and other group connections. STAs 20 and APs 10 may communicate according to WLAN radio and baseband protocol for physical and media access control (MAC) layers from IEEE 802.11 and versions including, but not limited to, 802.11b, 802.11g, 802.11a, 802.11n, 802.11ac, 802.11ad, 802.11ah, 802.11ax, 802.1 lay, etc. In some other implementations, peer-to-peer connections or ad hoc networks may be implemented within the WLAN 100.

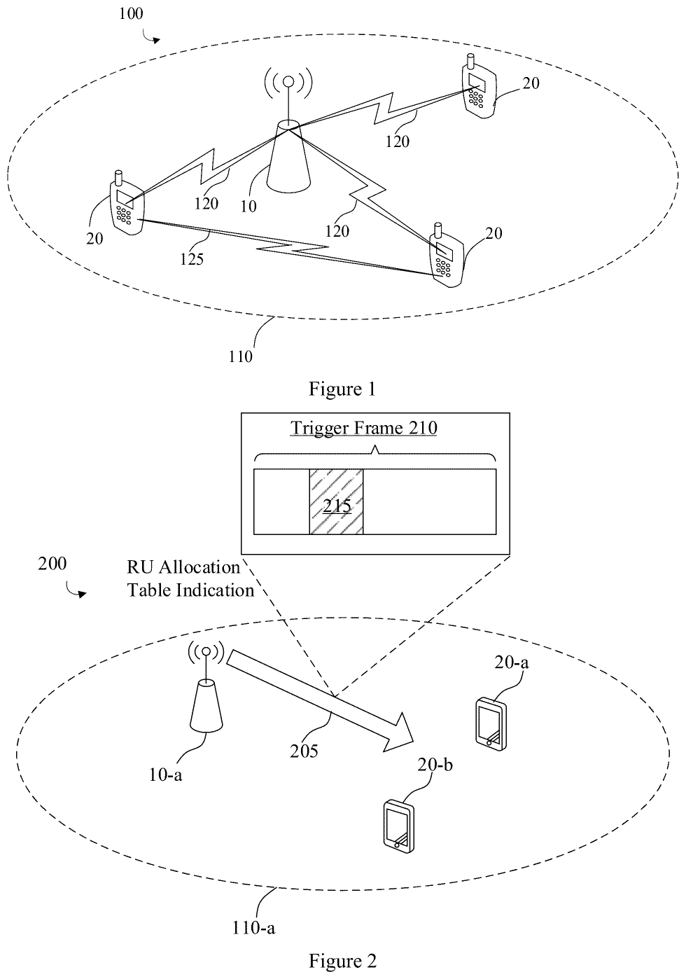

FIG. 2 illustrates an example of a wireless communications system according to another embodiment of the present disclosure. The wireless communications system 200 may be an example of a next generation or EHT Wi-Fi system and may include an AP 10-a and STAs 20-a and 20-b, and a coverage area 110-a, which may be examples of components described with respect to FIG. 1. The AP 10-a may transmit a trigger frame 210 including a resource unit (RU) allocation table indication 215 on the downlink 205 to the STAs 20.

In some implementations, the wireless communications system 200 may be a next generation Wi-Fi system (such as, an EHT system). In some implementations, wireless communications system 200 may also support multiple communications systems. For instance, wireless communications system 200 may support EHT communications and HE communications. In some implementations, the STA 20-a and the STA 20-b may be different types of STAs. For example, the STA 20-a may be an example of an EHT STA, while the STA 20-b may be an example of an HE STA. The STA 20-b may be referred to as a legacy STA.

In some instances, EHT communications may support a larger bandwidth than legacy communications. For instance, EHT communications may occur over an available bandwidth of 320 MHz, whereas legacy communications may occur over an available bandwidth of 160 MHz. Additionally, EHT communications may support higher modulations than legacy communications. For instance, EHT communications may support 4K quadrature amplitude modulation (QAM), whereas legacy communications may support 1024 QAM. EHT communications may support a larger number of spatial streams (such as, space-time-streams) than legacy systems. In one non-limiting illustrative example, EHT communications may support 16 spatial streams, whereas legacy communications may support 8 spatial streams. In some cases, EHT communications may occur a 2.4 GHz channel, a 5 GHz channel, or a 6 GHz channel in unlicensed spectrum.

In some implementations, AP 10-a may transmit a trigger frame 210 to one or more STAs 20 (such as, STA 20-a and STA 20-b). In some implementations, the trigger frame may solicit an uplink transmission from the STAs 20 or peer-to-peer transmission between the STAs 20. However, the trigger frame 210 may be received by an EHT STA 20-a and HE STA 20-b. The trigger frame 210 may be configured to solicit an uplink transmission from only HE STAs 20-b. In some implementations, trigger frame 210 may be configured to solicit an uplink transmission from EHT STAs 20-a. In some other implementations, the trigger frame 210 may be configured to solicit an uplink transmission from one or more EHT STAs 20-a and one or more HE STAs 20-b.

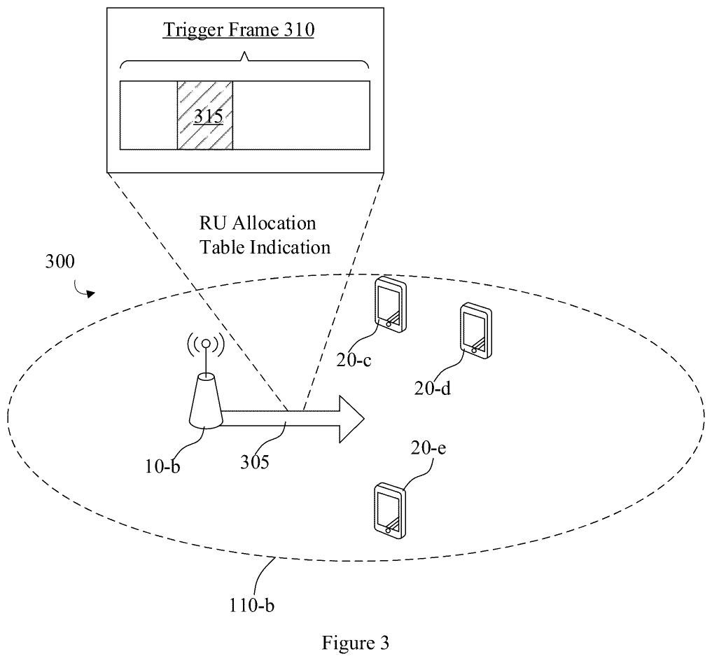

FIG. 3 illustrates an example of a wireless communications system according to another embodiment of the present disclosure. The wireless communications system 300 may be an example of a post-EHT Wi-Fi system and may include an AP 10-b. AP 10-b may be an example of a post-EHT AP 10. The wireless communications system 300 may include HE STA 20-c, EHT STA 20-d, and post-EHT STA 20-c, and a coverage area 110-b, which may be examples of components described with respect to FIG. 1. The AP 10-b may transmit a trigger frame 310 including an RU allocation table indication 315 on the downlink 305 to the STAs 20. In some implementations, STAs 20 may be referred to as clients.

In some implementations, an EHT AP 10 may serve both HE STAs 20 and EHT STAs 20. The EHT AP 10 may send a trigger frame that may trigger a response from HE STAs 20 only, from EHT STAs 20 only, or from both HE STAs 20 and EHT STAs 20. STAs 20 that are scheduled in the trigger frame may respond with trigger-based PPDUs. In some implementations, an EHT AP 10 may trigger HE STAs 20 (and not EHT STAs 20) by sending an HE trigger frame format. In some implementations, an EHT AP 10 may trigger EHT STAs 20 (and not EHT STAs 20) by sending an HE trigger frame format or an HE trigger frame format including some field or bit allocation adjustments. In some implementations, an EHT AP 10 may trigger EHT STAs 20 and HE STAs 20 by sending an HE trigger frame format including some field or bit allocation adjustments. In some implementations, the trigger frame may solicit peer-to-peer transmission between the STAs 20.

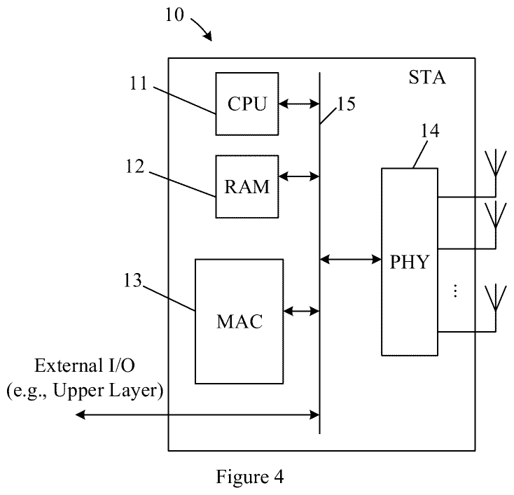

FIG. 4 is a block diagram showing an example of wireless station hardware according to an embodiment of the present disclosure. A STA 10 includes one MAC 13 and one PHY 14. The functions implemented in the MAC 13 and PHY 14 can be the same as defined in IEEE 802.11. They are coupled by a bus to call the functions and send information to each other. CPU 11 and RAM 12 on the bus are used to process the functions in the MAC 13 and PHY 14. The bus 15 is also coupled with external I/O, which is linked to the upper layer. The PHY 14 is also associated with RF circuitry (not shown) which operates on sub 7 GHz channel (e.g., 2.4 GHz, 5 GHz, 6 GHz), or other channel (e.g., 60 GHz).

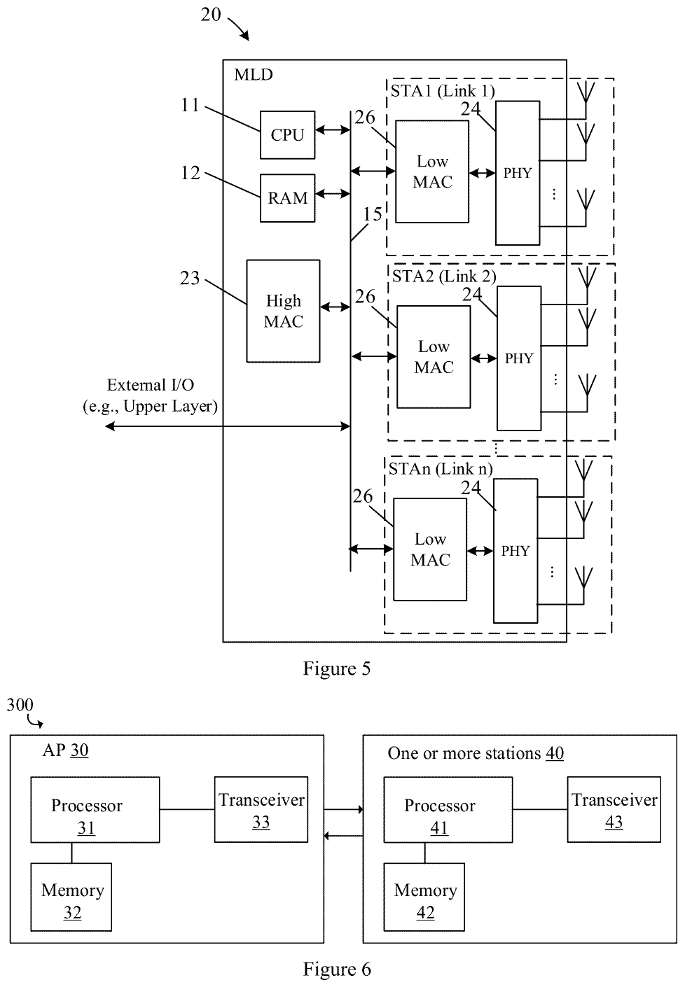

FIG. 5 is a block diagram showing an example of wireless multi-link device hardware according to an embodiment of the present disclosure. A multi-link device (MLD) 20 includes one high MAC 23 with one or more low MAC 26. The functions implemented in the high MAC 23 and low MAC 26 can be the same as defined in IEEE 802.11be. They are coupled by a bus to call the functions and send information to each other. CPU 11 and RAM 12 on the bus 15 are used to process the functions in the high MAC 23 and low MAC 26. The bus 15 is also coupled with external I/O, which is inked to the upper layer. Each low MAC 26 which associates with PHY 24 functionality and RF circuitry (not shown) could represent a STA that is affiliated with the MLD 20. Each STA operates on a different link which operates on a different channel frequency, e.g., 2.4 GHz, 5 GHz, 6 GHz, and 60 GHz. Note that a STA 10 shown in FIG. 4 can be regarded as a MLD 20 which only has one STA.

FIG. 6 illustrates one or more stations (STAs) and an access point (AP) of communication in a wireless communications system according to an embodiment of the present disclosure. FIG. 6 illustrates that, the wireless communications system 300 includes an access point (AP) 30 and one or more stations (STAs) 40. The AP 30 may include a memory 32, a transceiver 33, and a processor 31 coupled to the memory 32 and the transceiver 33. The one or more STAs 40 may include a memory 42, a transceiver 43, and a processor 41 coupled to the memory 42 and the transceiver 43. The processor 31 or 41 may be configured to implement proposed functions, procedures and/or methods described in this description. Layers of radio interface protocol may be implemented in the processor 31 or 41. The memory 32 or 42 is operatively coupled with the processor 31 or 41 and stores a variety of information to operate the processor 31 or 41. The transceiver 33 or 43 is operatively coupled with the processor 31 or 41, and the transceiver 33 or 43 transmits and/or receives a radio signal.

The processor 31 or 41 may include application-specific integrated circuit (ASIC), other chipset, logic circuit and/or data processing device. The memory 32 or 42 may include read-only memory (ROM), random access memory (RAM), flash memory, memory card, storage medium and/or other storage device. The transceiver 33 or 43 may include baseband circuitry to process radio frequency signals. When the embodiments are implemented in software, the techniques described herein can be implemented with modules (e.g., procedures, functions, and so on) that perform the functions described herein. The modules can be stored in the memory 32 or 42 and executed by the processor 31 or 41. The memory 32 or 42 can be implemented within the processor 31 or 41 or external to the processor 31 or 41 in which case those can be communicatively coupled to the processor 31 or 41 via various means as is known in the art.

In some embodiments, the processor 41 of a first non-AP STA of the one or more STAs 40 is configured to establish a communication link with the AP 30, establish tunneled direct link setup (TDLS) link with a second non-AP STA of the one or more STAs 40, perform peer-to-peer communication with the second non-AP STA during the TDLS link, and in response to at least one communication condition meeting a first condition, communicate with the second non-AP STA via the AP 30 using the communication link.

In some embodiments, the processor 31 of the AP 30 or the processor 41 of a first node of the one or more STAs 40 is configured to establish a communication session with a second node while the first node operates as a first-node type, announce a transition of the first node from the first-node type to a second node-type to the second node, and transition from the first-node type to the second-node type.

In some embodiments, the processor 41 of a first node of the one or more STAs 40 is configured to establish a communication session with a second node while the second node operates as a first-node type, receive an announcement of a transition of the second node from the first-node type to a second-node type from the second node, and keep the communication session with the second node or establishing another communication session with the second node after the announcement is received.

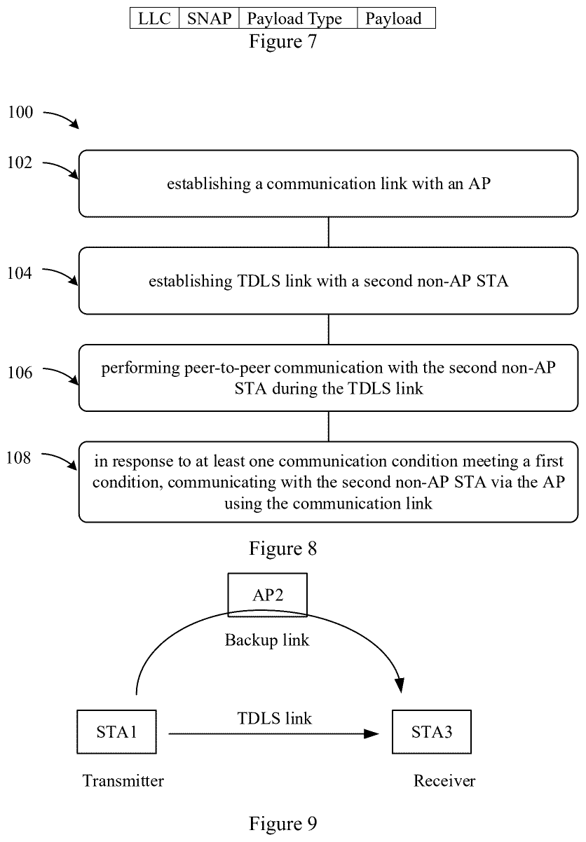

In current IEEE 802.11 network, two peer STAs affiliated with the same basic service set (BSS) can set up a tunneled direct link setup (TDLS) link for peer-to-peer (P2P) transmissions between each other. TDLS uses EtherType 89-0d frames for TDLS signaling. The Payload field of the EtherType 89-0d frame contains one of the TDLS Action fields specified in Clause 9.6.12 (TDLS Action field formats) of IEEE 802.11REVme D2.0 followed by zero or more Vendor Specific elements. The EtherType 89-0d frame body is specified in FIG. 7, omitting any possible security header and trailer.

Two Wi-Fi devices that are associated with the same BSS can set up a TDLS link for Peer-to-peer (P2P) communication. However, the Wi-Fi devices can also be mobile devices. When the devices start to move, the link quality may degrade especially when the distance between the two devices increases. Then, the two devices cannot transmit between each other. Furthermore, in current IEEE 802.11 network, (a) block acknowledgement (BA) operation does not support multi-hop transmission; (b) multi-hop transmission cannot be finished within one transmission opportunity (TXOP).

FIG. 8 is a flowchart of a method 100 of wireless communication of a first non-AP station according to an embodiment of the present disclosure. Referring to FIG. 8, the method 100 includes the followings. In Steps 102 and 104, the first non-AP STA establishes a communication link (e.g., a backup link) with an AP and a tunneled direct link setup (TDLS) link with a second non-AP STA, respectively. In Step 106, the first non-AP STA performs peer-to-peer communication with the second non-AP STA during the TDLS link. In Step S108, in response to at least one communication condition meeting a first condition, the first non-AP STA communicates with the second non-AP STA via the AP using the communication link. In addition, in response to the at least one communication condition meeting a second condition, the first non-AP STA may switch back to the TDLS link from the communication and use the TDLS link to communicate with the second non-AP STA. The first condition may be a condition that the link quality is not good enough for transmission via TDLS link (for example, when the second non-AP STA moves far from the first non-AP STA), while the second condition may be a condition that the link quality is good enough for transmission via TDLS link (for example, when the second non-AP STA moves close to the first non-AP STA). That is, when the link quality is good enough, the first non-AP STA communicates with the second non-AP STA by using TDLS link; when the link quality is not good enough, the first non-AP STA communicates with the second non-AP STA via the AP using the communication link. With this method, wireless communication between the first non-AP STA and the second non-AP STA is enhanced with mobility.

In an embodiment of the present disclosure, the method further includes receiving a block acknowledgment (BA) frame from the second non-AP STA via the AP using the communication link after one or more data frames associated with the BA frame are received by the second non-AP STA.

In an embodiment of the present disclosure, the method further includes retransmitting a frame via the AP using the communication link, wherein a total number of retransmissions of the frame via the TDLS link and the communication link is limited by a retry count.

In an embodiment of the present disclosure, the method further includes transmitting a transmission-opportunity-sharing (RTX) frame to the AP to share transmission opportunity (TXOP) with the AP, during which the AP forwards a data frame from the first non-AP STA to the second non-AP STA and/or forwards a BA frame associate with the data frame from the second non-AP STA to the first non-AP STA.

In an embodiment of the present disclosure, the method further includes transmitting to the AP a data frame with an indication of TXOP sharing with the AP, during the shared TXOP, the AP forwards the data frame from the first non-AP STA to the second non-AP STA and/or forwards a BA frame associate with the data frame from the second non-AP STA to the first non-AP STA.

FIG. 9 illustrates TDLS link and backup link according to an embodiment of the present disclosure. Two peer STAs, denoted as STA 1 and STA 3, are exchanging frames between each other directly. They associate with the same AP, denoted as AP2. They can transmit data frames and block acknowledgement (BA) frames via two types of links as shown in FIG. 9. The two types of links are TDLS link and backup link. For the TDLS link, the transmitter STA, e.g., STA1, can transmit frames to the receiver STA, e.g., STA3, directly via TDLS link that is set up between them successfully. For the backup link: the transmitter STA, e.g., STA1, can ask the AP to relay the frames to the receiver STA, e.g., STA3.

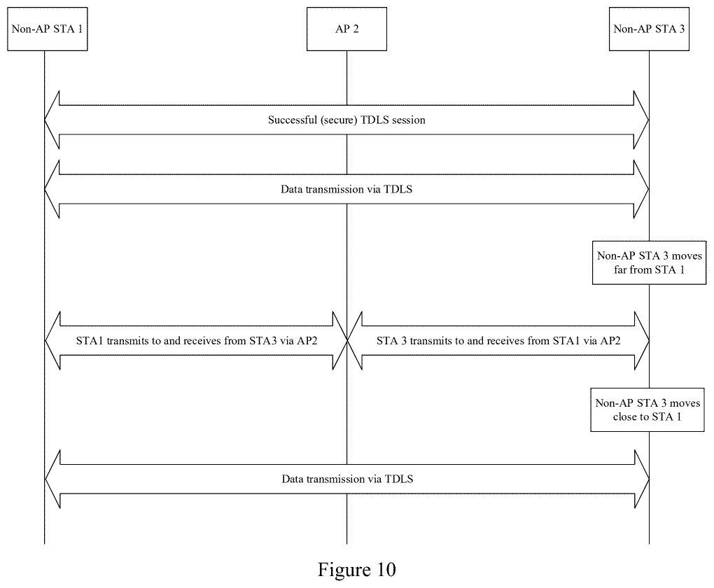

In some embodiments, refer to FIG. 10, which illustrates switching between TDLS link and backup link. Non-AP STA1 and non-AP STA3 associate with AP2. After STA1 and STA3 set up TDLS session successfully between each other, they transmit frames to each other directly over the TDLS link. However, due to the mobility of STA3, it moves far from STA1. Then, STA1 and STA3 are not able to send frames directly to each other via TDLS link as shown in FIG. 10. For example, STA1 may realize that the TDLS link quality is not good by observing a large amount of packet loss. Or STA1 starts to use low MCS to transmit packets to STA3 via TDLS link.

In some embodiments, STA1 transmits packets to AP2 first then let AP2 forward the packets to STA3. That is, STA1 transmits packets to STA3 via backup link. For data packets that are associated with immediate BA feedback, STA3 should respond the BA frame back via backup link immediately after it receives the data packets. It is possible that if STA3 senses that the TDLS link quality is good enough, then STA3 may transmit BA back to STA1 via TDLS link.

In some embodiments, refer to FIG. 10, which illustrates switching between TDLS link and backup link. When STA1 senses that STA3 moves close to STA1 and the link quality is good enough for the transmission via TDLS link, it can switch back to TDLS link for the transmission as shown in FIG. 10. The link quality can be measured by the received signal strength indicator (RSSI) or the signal-to-noise ratio (SNR) of the packets that are transmitted by STA3. When STA1 measures that the RSSI or the SNR of the packets is higher than a threshold, e.g., −60 dB RSSI, then STA1 regards the link quality is good enough for the transmission via TDLS link. Note that the packet transmitted by STA3 may transmit to any STA.

In some embodiments, when the packet loss occurs on TDLS link, the transmitter STA can retransmit the frames via backup link. The total number of retransmissions of a frame via TDLS link and backup link cannot exceed the retry count. The transmitter STA can share the TXOP with AP so that AP can relay the frames from the transmitter STA to the receiver STA and forwards the solicited frames, e.g., BA frames, from the receiver STA to the transmitter STA during the shared TXOP. In some embodiments, during the shared TXOP, AP can only transmit the frames that are relayed to the receiver STA. In some embodiments, the shared TXOP ends when AP transmits the solicited frames from the receiver STA to the transmitter STA successfully. In some embodiments, the BA can be carried by using EtherType 89-0d whose payload of the frame body is shown in FIG. 17.

In some embodiments, refer to FIG. 11, which shows an example of P2P transmission via backup link in multiple TXOPs. STA3 transmits a data frame which carries the data to STA1 via AP2. STA3 uses the frame as shown in FIG. 7 with the payload type field set to TDLS data and the payload field carries the data that STA3 intends to transmit to STA1. When AP2 receives the frame, it responds an Ack frame to indicate that it receives the frame. Then, AP2 contends the channel to forward the frame to STA1 and STA1 responds an Ack frame to indicate that it receives the frame from AP2 successfully. Next, STA1 contends the channel and transmits the BA frame in response to the data received from STA3 via backup link. The BA frame can be carried by the payload field using the frame format shown in FIG. 7. So AP2 receives the BA frame first and responds an Ack frame to indicate it receives the BA to STA3. In the next TXOP of AP2, it forwards the BA frame to STA3 and STA3 also responds an Ack frame to indicate that it receives the BA frame successfully.

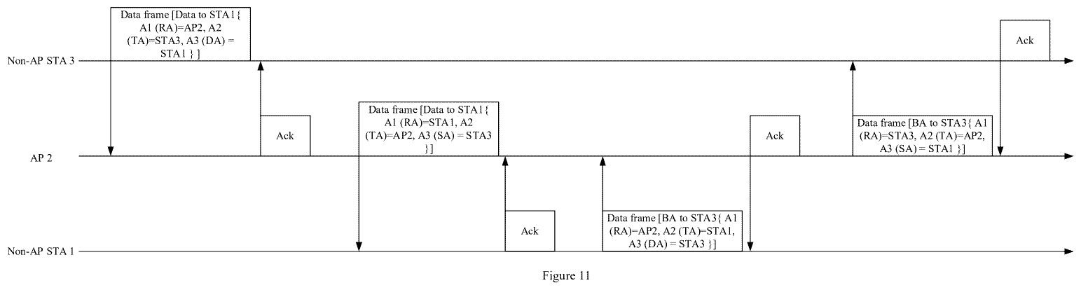

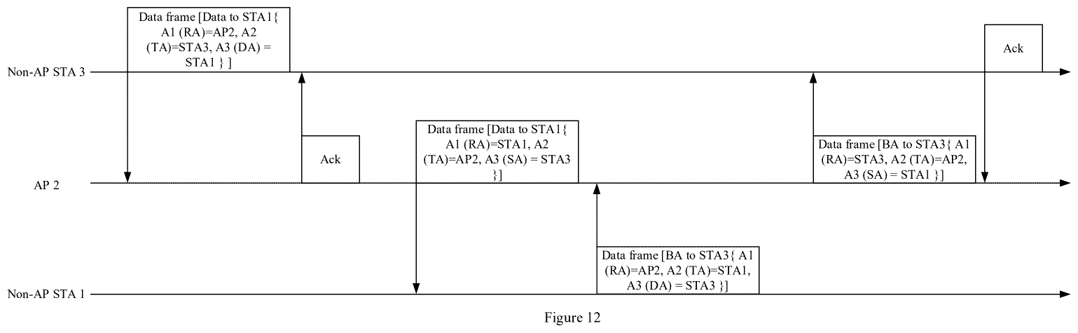

In some embodiments, refer to FIG. 12, which shows another example of P2P transmission via backup link in multiple TXOPs. Compared with the example shown in FIG. 11, the difference is that when AP2 forwards the data frame to STA1, STA1 responds the BA frame immediately.

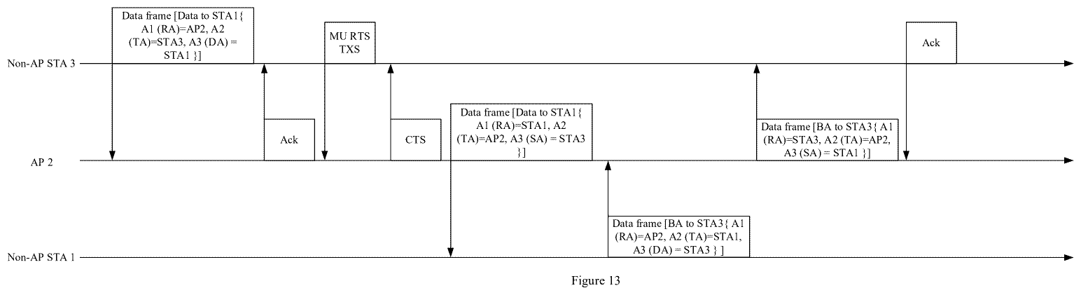

In some embodiments, refer to FIG. 13, which shows an example of P2P transmission via backup link in a single TXOP. In this example, after STA3 transmits the data frame to AP2 for forwarding, it transmits a MU RTS TXS frame to AP2 to share TXOP with AP2. Then, AP2 responds CTS frame to indicates that it starts the shared TXOP. During the shared TXOP, AP2 forwards the data frame to STA1 and receives the BA frame from STA1 and forwards the BA frame back to STA3.

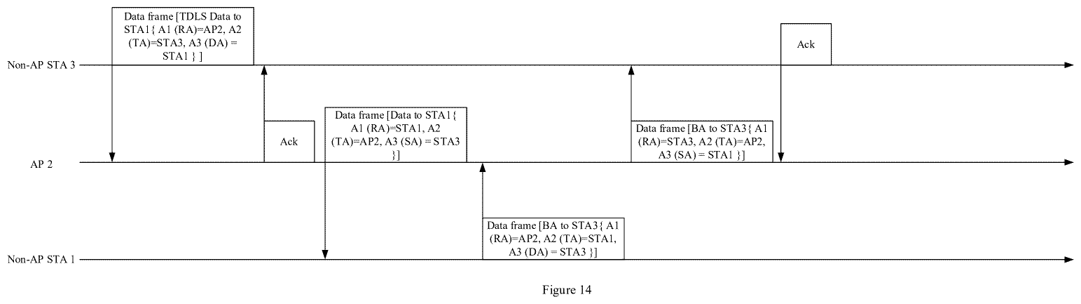

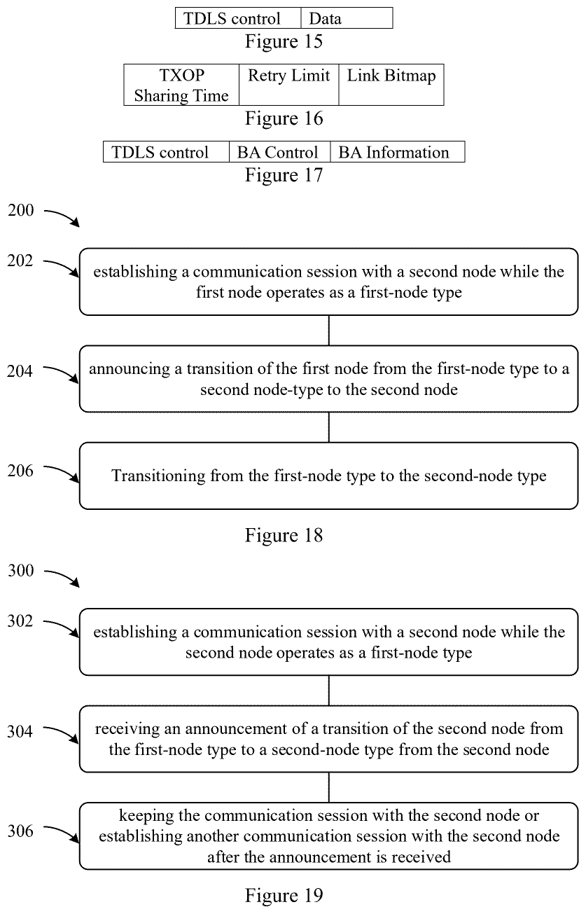

In some embodiments, refer to FIG. 14, which shows another example of P2P transmission via backup link in a single TXOP. Compared with the example shown in FIG. 13, when STA3 transmits the Data frame to AP2 for forwarding, the payload of data frame uses the format as shown in FIG. 15, which can indicate the TXOP sharing with AP2.

In some embodiments, refer to FIG. 15, which shows the format of Payload in EtherType 89-0d frame body when payload type is set to TDLS data. The Payload in EtherType 89-0d frame body contains TDLS control field. The format of TDLS control field is shown in FIG. 16. The TDLS control field includes the following fields: (i) TXOP Sharing Time: this field is set to indicate that the receiver of this field can using the shared TXOP time to finish the transmission via the backup link. If this TXOP sharing time field is set to 0, then it indicates that the receiver STA should contend TXOP for forwarding frames; (ii) Retry Limit: this field is set to indicate the maximum time of retransmissions of the frame that the receiver can try to forward the frame; (iii) Link Bitmap: Each bit of this field represents a link. When the bit of a link is set to “1”, then the frame can be transmitted/forwarded over that link. Otherwise, the bit of that link is set to “0”. It is possible that only the bit of the link that has successful TDLS session between the two peer STAs can be set to “1”. It is possible that the multiple bits of link bitmap are set to “1”. The data and BA frames can be forwarded over any link whose corresponding bit is set to “1”.

In some embodiments, refer to FIG. 17, which shows the format of Payload in EtherType 89-0d frame body when payload type is set to TDLS BA. The Payload in EtherType 89-0d frame body contains TDLS control field as shown in FIG. 16. BA Control field and BA information field are the same as defined in IEEE 802.11.

A Wi-Fi device, such as mobile phone, can be either a non-access point (AP) station (STA) or non-AP multi-link device (MLD) connected to a router, e.g., AP or AP MLD, or a soft AP or soft AP MLD which is connected to the internet via the cellular network. When the Wi-Fi device is a non-AP station or MLD, then the other W-Fi devices can exchange frames directly with it via peer-to-peer (P2P) link(s). When the Wi-Fi device is a soft AP, then the other Wi-Fi devices can exchange frames directly with it after they are associated with it successfully. Due to the traffic offloading between Wi-Fi network and cellular network, the Wi-Fi device may exchange its role between TDLS-peer STA and soft AP frequently over the link where it communicates with other Wi-Fi devices directly. This causes the communication interruption since the setup procedure is used to enable the direct communication after the role change of the Wi-Fi device.

Two peer STAs or MLDs, denoted as device 1 and device 2, are exchanging frames between each other directly. The proposed solution provides uninterrupted data transmission service when one peer STA (or MLD), e.g., device 2, of the data transmission changes its role between soft AP (or AP MLD) and TDLS peer STA (or MLD). To achieve this, when the role of the device 2 changes, it sends a frame to device 1 indicating that its role is changing and device 1 should prepare for the setup procedure for the new type of link.

In some embodiments, if device 2 changes from soft AP to non-AP, the link(s) between the two devices turns into peer-to-peer link(s) and the TDLS setup procedure should be launched immediately in order to not interrupt the data transmission. If device 2 changes from non-AP to soft AP, the link(s) between the two devices turns into downlink (DL)/uplink (UL) link(s) and device 1 may keep the TDLS link with device 2 for the transmission, and/or launch the (re) association procedure with device 2 for the transmission immediately. In some embodiments, the block acknowledgement (BA) setup between the two STAs may not be changed. i. The traffic identifier (TID)-to-Link mapping may not be changed. The security setup (e.g., keys) between device 1 and device 2 may not be changed. In some embodiments, if device 1 is a STA, then the STA does not switch its channel. If device 1 is a MLD, then the STAs affiliated with the MLD do not switch the channel on the links that are communicating with device 2. If device 2 is a STA, then the STA does not switch its channel. If device 2 is a MLD, then the STAs affiliated with the MLD do not switch the channel on the links that are communicating with device 1.

FIG. 18 is a flowchart of a method 200 of wireless communication of a first node (e.g., a peer STA transitioning to a soft AP or a soft AP transitioning to a peer STA) according to an embodiment of the present disclosure. Referring to FIG. 18, the method 200 includes the followings. In Step 202, the first node establishes a communication session (which can be tunneled direct link setup (TDLS) session in some cases or a link session with soft AP in some other cases) with a second node while the first node operates as a first-node type. In Step 204, the first node announces a transition of the first node from the first-node type to a second node-type to the second node. In Step 206, the first node transitions from the first-node type to the second-node type. It is noted that in some cases the first-node type is a peer station (STA), and the second-node type is a soft access point (AP); in some other cases the first-node type is a soft access point (AP), and the second-node type is a peer station (STA). With this method, necessary setup procedure can be prepared as role change (i.e., a transition from the first-node type to the second-node type), thereby achieving uninterrupted data transmission.

In an embodiment of the present disclosure, the communication session is tunneled direct link setup (TDLS) session.

In an embodiment of the present disclosure, the method further includes maintaining the communication session with the second node once the first node transitions to the second node-type.

In an embodiment of the present disclosure, the method further includes performing a procedure to associate or reassociate with the second node for data transmission once the first node transitions to the second node-type, wherein the procedure to associate or reassociate with the second node is performed after switching time during which the first node transitions to the second node-type.

In an embodiment of the present disclosure, the first-node type is a peer station (STA), and the second-node type is a soft access point (AP).

In an embodiment of the present disclosure, the communication session is a link session with soft AP.

In an embodiment of the present disclosure, the method further includes establishing another communication session with a third node once the first node transitions from the first-node type to the second-node type, wherein the another communication session is established with the third node before switching time during which the first node transitions to the second node-type.

In an embodiment of the present disclosure, the method further includes establishing tunneled direct link setup (TDLS) session with the second node once the first node transitions from the first-node type to the second-node type, wherein the TDLS session is established with the second node after switching time during which the first node transitions to the second node-type.

In an embodiment of the present disclosure, the first-node type is a soft access point (AP), and the second-node type is a peer station (STA).

FIG. 19 is a flowchart of a method 300 of wireless communication of a first node (e.g., a peer STA) according to another embodiment of the present disclosure. Referring to FIG. 19, the method 300 includes the followings. In Step 302, the first node establishes a communication session (which can be tunneled direct link setup (TDLS) session in some cases or a link session with soft AP in some other cases) with a second node while the second node operates as a first-node type. In Step 304, the first node receives an announcement of a transition of the second node from the first-node type to a second-node type from the second node. In Step 306, the first node keeps the communication session with the second node or establishes another communication session with the second node after the announcement is received. It is noted that in some cases the first-node type is a peer station (STA), and the second-node type is a soft access point (AP); in some other cases the first-node type is a soft access point (AP), and the second-node type is a peer station (STA). With this method, necessary setup procedure can be prepared as role change (i.e., a transition from the first-node type to the second-node type), thereby achieving uninterrupted data transmission.

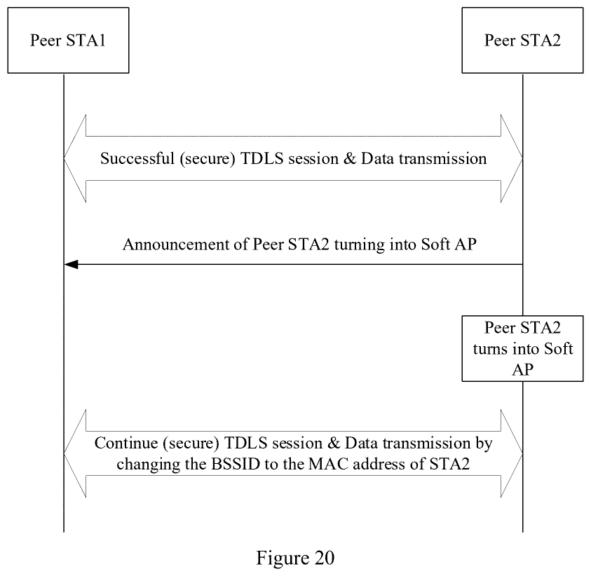

In some embodiments, refer to FIG. 20, which illustrates an example of keeping TDLS link when STA2 switches from Peer STA to Soft AP. Two peer STAs, STA1 and STA2, have set up TDLS successfully for the peer-to-peer communication (TDLS session as shown in FIG. 20) between each other. When STA2 turns into a soft AP, STA2 sends an announcement to STA1 indicating that it is going to switch from a non-AP STA to a soft AP. After that, STA2 turns into a soft AP. STA1 continues using the TDLS session to transmit data with STA2.

The announcement could be a frame, such as an action frame (as defined in IEEE 802.11) carrying the element as shown in FIG. 23. STA1 should not transmit frames to STA2 until STA2 finish the changing from non-AP to soft AP. This time is indicated by the switching time in the element as shown in FIG. 23. In Option1, STA1 continues the TDLS session except that the BSSID of the TDLS frame is set to the MAC address of STA2. In Option2, if STA2 is a multi-AP with respect to the AP that STA1 and STA2 are associated. Then, STA1 and STA2 continue the TDLS session without any changes.

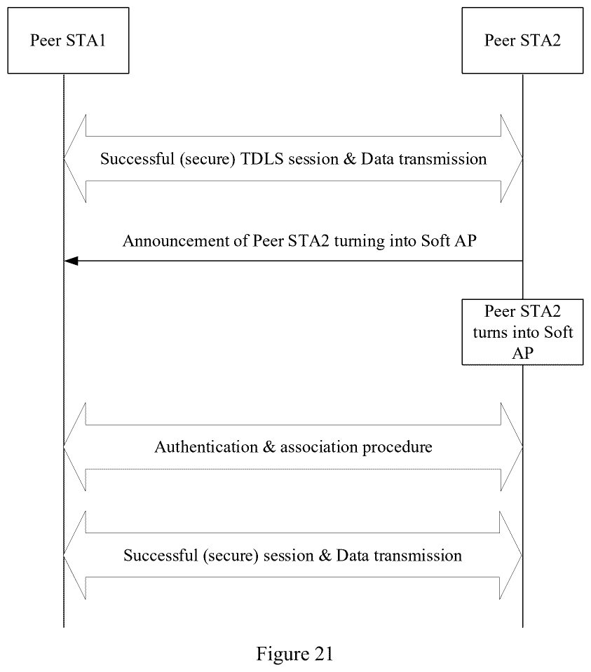

In some embodiments, refer to FIG. 21, which illustrates an example of reassociation immediately after STA2 changes from Peer STA to Soft AP. Compared with FIG. 20, after STA2 turns into soft AP, STA1 starts to associate with STA2 immediately.

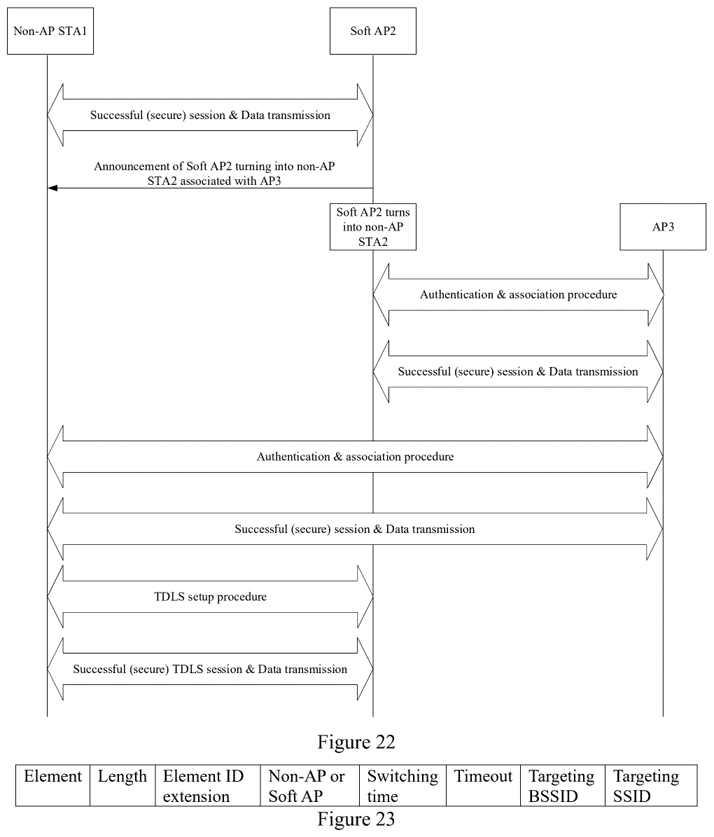

In some embodiments, refer to FIG. 22, which illustrates an example of setting up TDLS link after STA2 changes from soft AP to Peer STA. Non-AP STA1 is associated with soft AP2 successfully. Before soft AP2 turns into non-AP STA, it transmits an announcement to non-AP STA1 indicating that it is going to turn into non-AP STA. After soft AP2 turns into non-AP STA, it associates with AP3 for data transmission. Meanwhile non-AP STA1 associates with AP3 for data transmission as well. Then, STA1 and STA2 can launch a TDLS setup procedure for peer-to-peer communication between each other.

The announcement could be a frame, such as an action frame (as defined in IEEE 802.11) carrying the element as shown in FIG. 23. STA1 may not transmit frames to STA2 until the TDLS setup between STA1 and STA2 is established successfully. STA1 should finish the association procedure with AP3 before the timeout indicated in the element as shown in FIG. 23. Before association procedure, authentication procedure may be also performed. This procedure may not start until it reaches the switching time as indicated in the element as shown in FIG. 23. STA2 should finish the association procedure with AP3 before the switching time indicated in the element as shown in FIG. 23.

In some embodiments, refer to FIG. 23, which shows the format of the fast transition between non-AP and soft AP element. The format of the fast transition may include the followings fields. Element field and element ID extension field indicate the element is fast transition between non-AP and soft AP element. Length field indicates the length of the fast transition between non-AP and soft AP element. Non-AP or Soft AP field is set to indicate whether the transmitter STA of the fast transition between non-AP and soft AP element is going to switch to non-AP or soft AP. This field can be one-bit indication. For example, when this bit is set to “0”, then the transmitter of the element is going to switch to be non-AP. When this bit is set to “1”, then the transmitter of the element is going to switch to be soft AP. Switching time field is set to indicate the time that the transmitter is needed to finish the change of its role as indicated in Non-AP or Soft AP field. Timeout field is set to indicate the time before which the receiver of the element is used to finish the setup procedure for the targeting type of link. Targeting BSSID field is set to indicate the BSSID of the AP that the receiver is going to associate. If Non-AP or Soft AP field is set to “non-AP”, then the targeting BSSID is set to the BSSID of the AP that the transmitter of the element is going to associate. If Non-AP or Soft AP field is set to “soft AP”, then the targeting BSSID is set to the MAC address of the transmitter of the element. Targeting SSID field is set to indicate the SSID of the AP that the receiver is going to associate. If Non-AP or Soft AP field is set to “non-AP”, then the targeting SSID is set to the SSID of the AP that the transmitter of the element is going to associate. If Non-AP or Soft AP field is set to “soft AP”, then the targeting SSID is set to the SSID of the transmitter of the element.

In some embodiments, when the transmitter of the element sets the Non-AP or Soft AP field to “soft AP”, the receiver of the element should finish the association with the transmitter of the element before timeout. The association procedure should be launched after the switching time.

In some embodiments, when the setup procedure for the targeting type of link is finished before the timeout, the BA setup, the TID-to-Link mapping, the security setup (e.g., keys) between the two STAs may not be changed.

In some embodiments, if the transition procedure cannot be finished before the timeout, it may use the regular procedure as described in IEEE 802.11. The BA setup, the TID-to-Link mapping, the security setup (e.g., keys) between the two STAs may be discarded and they perform new negotiations.

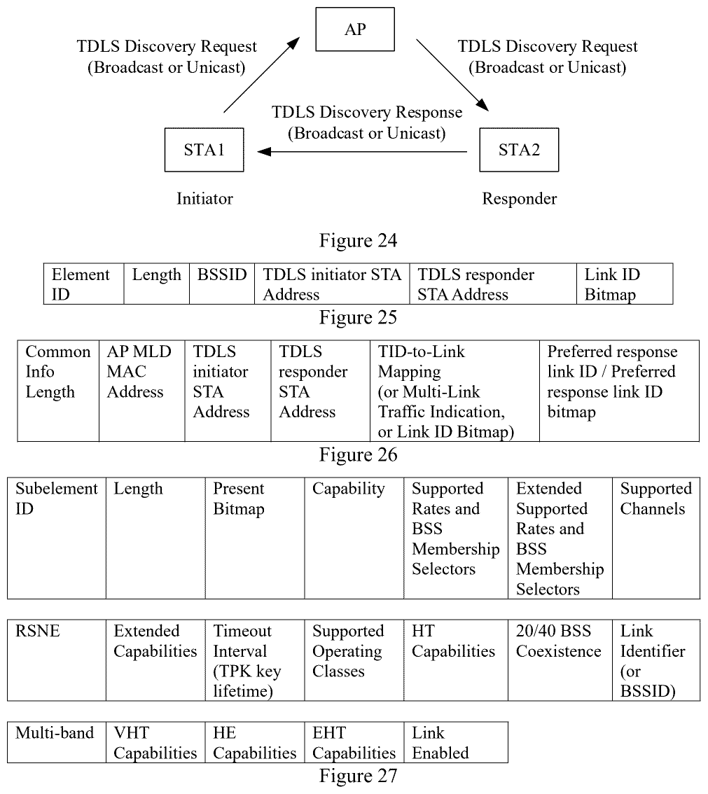

In current IEEE 802.11 procedure, tunneled direct link setup (TDLS) discovery procedure as shown in FIG. 24 is used for an initiator peer STA (STA1) to discover TDLS direct link with another responder peer STA (STA2). Then, the peer STA can set up TDLS direct link with the other peer STA for the P2P transmission over the TDLS direct link. The information for TDLS Discovery Request Action field is shown in Table 1. The TDLS Discovery Response frame Action field format is shown in Table 2.

TABLE 1
Information for TDLS Discovery Request Action field

| Order | Information | Notes |
|---|---|---|
| 1 | Category | The Category field is defined in 9.4.1.11 (Action field). |
| 2 | TDLS Action | The TDLS Action field is defined in 9.6.12.1 (General). |
| 3 | Dialog Token | The Dialog Token field can be used to match TDLS Discovery Response |
| | | frames to the corresponding TDLS Discovery Request frame. The dialo [symbol] |
| | | token is specified in 9.4.1.12 (Dialog Token field). |
| 4 | Link Identifier | The Link Identifier element is specified in 9.4.2.61 (Link Identifier |
| | | element). |
| 5 | Multi-band | The Multi-band element is optionally present if |
| | | dot11MultibandImplemented is true. |
| 6 | Multi-Link | The TDLS Multi-Link element is present if the STA is affiliated with a |
| | | non-AP MLD; otherwise, it is not present. |

[symbol]

indicates data missing or illegible when filed

TABLE 2
TDLS Discovery Response frame Action field format

| Order | Information | Notes |
|---|---|---|
| 1 | Category | The Category field is defined in 9.4.1.11 (Action field). |
| 2 | Public Action | The Public Action field is defined in 9.6.7.1 (Public Action frames). |
| 3 | Dialog Token | The Dialog Token field can be used to match TDLS Discovery Response |
| | | frames to the corresponding TDLS Discovery Request frame. The |
| | | dialog token is specified in 9.4.1.12 (Dialog Token field). |
| 4 | Capability | The Capability field indicates the capabilities of the STA. The Capability |
| | | field is defined in 9.4.1.4 (Capability Information field). |
| 5 | Supported Rates | The Supported Rates and BSS Membership Selectors element indicates |
| | and BSS | the rates supported by the STA. The Supported Rates and BSS |
| | Membership | Membership Selectors element is defined in 9.4.2.3 (Supported Rates |
| | Selectors | and BSS Membership Selectors element). |
| 6 | Extended | The Extended Supported Rates and BSS Membership Selectors element |
| | Supported Rates | is present if there are more than eight supported rates and BSS |
| | and BSS | membership selectors, and it is optional otherwise. |
| | Membership | The Extended Supported Rates and BSS Membership Selectors element |
| | Selectors | is defined in 9.4.2.12 (Extended Supported Rates and BSS Membership |
| | | Selectors element). |
| 7 | Supported | The Supported Channels element is present if the TDLS Channel |
| | Channels | Switching subfield is equal to 1. The Supported Channels element is |
| | | defined in 9.4.2.17 (Supported Channels element). |
| 8 | RSNE | The RSNE is present if security is required on the TDLS direct link (see |
| | | 12.7.8.1 (General)). The RSNE is defined in 9.4.2.24 (RSNE). |
| 9 | Extended | The Extended Capabilities element is present if any of the fields in this |
| | Capabilities | element are nonzero. The Extended Capabilities element is defined in |
| | | 9.4.2.26 (Extended Capabilities element). |
| 10 | Timeout Interval | The TIE contains the TPK key lifetime. It is present if security is |
| | (TPK key | required on the TDLS direct link (see 12.7.8.1 (General)). The TIE is |
| | lifetime) | defined in 9.4.2.48 (TIE). |
| 11 | Supported | The Supported Operating Classes element is present if the TDLS |
| | Operating | Channel Switching subfield is equal to 1. |
| | Classes | |
| 12 | HT Capabilities | The HT Capabilities element is present when |
| | | dot11HighThroughputOptionImplemented is true. |
| | | The HT Capabilities element is defined in 9.4.2.55 (HT Capabilities |
| | | element). |
| 13 | 20/40 BSS | The 20/40 BSS Coexistence element is present when |
| | Coexistence | dot112040BSSCoexistenceManagementSupport is true. The 20/40 BSS |
| | | Coexistence element is defined in 9.4.2.59 (20/40 BSS Coexistence |
| | | element). |
| 14 | Link Identifier | The Link Identifier element is specified in 9.4.2.61 (Link Identifier |
| | | element). |
| 15 | Multi-band | The Multi-band element is optionally present if |
| | | dot11MultibandImplemented is true. |
| 16 | VHT Capabilities | VHT Capabilities element (optional). The VHT Capabilities element is |
| | | present if dot11VHTOptionImplemented is true. The VHT Capabilities |
| | | element is defined in 9.4.2.157 (VHT Capabilities element). |
| 19 | HE Capabilities | The HE Capabilities element is present if dot11HEOptionImplemented is |
| | | true; otherwise, it is not present, The HE Capabilities element is |
| | | defined in 9.4.2.248 (HE Capabilities element(11ax)). |
| 20 | EHT Capabilities | The EHT Capabilities element is present if |
| | | dot11EHTOptionImplemented is true; otherwise, it is not present. |
| 21 | Multi-Link | The TDLS Multi-Link element is present if the STA is affiliated with a |
| | | non-AP MLD; otherwise, it is not present. |

The efficiency of TDLS discovery procedure is low in current IEEE 802.11 procedure because the TDLS discovery procedure can only be used for a TDLS direct link on a single link and the TDLS discovery procedure cannot discover an off-channel TDLS direct link.

If a TDLS discovery procedure is for multiple TDLS direct links on different links, then the responder peer MLD does not know the states of the STAs affiliated with the initiator peer MLD. If an initiator peer STA is in sleeping mode, then the responder peer STA on the same link should not respond the TDLS discovery response frame. Therefore, the responder peer MLD should know the states of the STAs affiliated with the initiator peer MLD when it responds TDLS discovery response frame.

In this disclosure, one TDLS discovery procedure, i.e., one TDLS discovery request frame and response frame exchange, can be used for discovering multiple TDLS direct links. In some embodiments, a TDLS discovery procedure can be used to discover TDLS direct link on disabled or sleeping link. In some embodiments, a TDLS discovery procedure can be used to discover an off-channel TDLS direct link. When the peer STAs operate on off-channel TDLS direct link, they may not associate with any AP on any link. In some embodiments, a TDLS discovery request can indicate which link(s) it prefers to receive the TDLS discovery response frame.

In some embodiments, TDLS discovery request action field may carry TDLS direct link information over multiple links. There are four options presented in this disclosure, as follows:

Option 1: Set BSSID in the Link Identifier field to the MAC address of AP MLD. The multi-link element may not present in the TDLS Discovery Request Action field. TDLS Discovery Request Action field may carry the TID-to-Link mapping element, or the Multi-Link Traffic Indication element, or the Link ID bitmap field. For the TID-to-Link mapping element, the default link mapping subfield in TID-to-Link mapping is set to 0; it is possible that the bit of the corresponding link in the link mapping of TID X subfield can be set to 1 even if that link is disabled between the initiator non-AP MLD and AP MLD; TDLS direct link can be set up on the links that at least one TID is mapped to that link in the TID-to-Link mapping. For the Multi-Link Traffic Indication element, it is possible that Multi-link Traffic Indication carries a Per-Link Traffic Indication Bitmap subfield with respect to a link that is disabled between the initiator non-AP MLD and AP MLD; TDLS direct link can be set up on the links that the corresponding Per-Link Traffic Indication Bitmap subfield has at least one bit set to 1 (i.e., indicate the traffic of at least one TID on that link).

Option 2: Define ML Link Identifier element as shown in FIG. 25 to replace Link Identifier element. For this option, BSSID subfield is set to the MAC address of the AP MLD; to discover TDLS peer STAs on multiple links, set the corresponding bits in the Link ID Bitmap to 1; the Multi-Link element may not present in the TDLS discovery request action field.

Option 3: Add TID-to-Link Mapping element or Multi-Link Traffic Indication element or Link ID bitmap field in the common Info field of the TDLS Multi-Link element as shown in FIG. 26. For this option, the BSSID field in Link Identifier element can be reserved; the Link Identifier element does not present if TDLS initiator STA Address field and TDLS responder STA Address field are added to the common Info field of the TDLS Multi-Link element; the link which is indicated in the TID-to-Link Mapping element or Multi-Link Traffic Indication element or Link ID bitmap field are the links that the initiator STA requests to have TDLS direct link information.

Option 4: Add Link Identifier elements in Link Info field of ML element as shown in FIG. 27. For this option, define Per-link Info subelement of the TDLS Multi-Link element carrying Link Identifier element or BSSID field. The BSSID field of each Per-link Info is set to the MAC address of the AP on a link.

In some embodiments, TDLS discovery response frame action field may carry TDLS direct link information over multiple links. All the same options in TDLS Discovery Request Action field. Per-Link Info subelement format of the TDLS Multi-Link element is defined as shown in FIG. 27 and is explained as follows. The BSSID field in the Link Identifier element directly under the TDLS Discovery Request Action field is set to the MAC address of the AP on a specific link (e.g., any link or preferred link). The TDLS Multi-Link element contains at least one Per-Link Info subelements. Each Per-Link Info subelement represents one TDLS channel over a single link. The Present Bitmap field indicates which fields are present in the Per-Link Info subelement. If a field is present in the Per-Link Info subelement, it represents the corresponding parameter setting of the TDLS direct link on that link. If a field is not present in the Per-Link Info subelement, then the corresponding parameter setting of the TDLS direct link on that link inherits from that in the TDLS Discovery Response frame Action field. Link Enabled field is set to indicate whether the link with respect with the Per-Link Info subelement is enabled or not. If the link is disabled, then the TDLS discovery response should not be transmitted over that link. Otherwise, the TDLS discovery response may be transmitted over that link. Link Enabled field has to set the link to be disabled when the link is an off-channel TDLS direct link.

In some embodiments, for the above options (i.e., Options 1 to 4), the off-channel TDLS direct link can be represented by setting the BSSID field in Link Identifier element to be wildcard BSSID, or using the Link ID 15 to represent the off-channel TDLS direct link.

In some embodiments, the TDLS discovery request indicates which link or which links it prefers to receive the TDLS discovery response frame. There are three options presented in this disclosure, as follows:

Option 1: the TDLS discovery request action field (or element) carries. For this option, the preferred response link ID field to tell which link should be used to transmit TDLS discovery response frame, or the preferred response link ID bitmap field to tell which links should be used to transmit TDLS discovery response frame. For example, the preferred response link ID field or the preferred response link ID bitmap field can be added in the Common Info field of the TDLS Multi-Link element as shown in FIG. 26.

Option 2: the peer MLD responds the TDLS discovery frames over the links. Each TDLS discovery frame is for the TDLS discovery for the single link where the frame is transmitted.

Option 3: the peer MLD responds to the TDLS discovery response frame carrying the information of multiple TDLS direct links over a link that is one of the TDLS direct links in the frame and whose frequency is higher than other TDLS direct links in the frame.

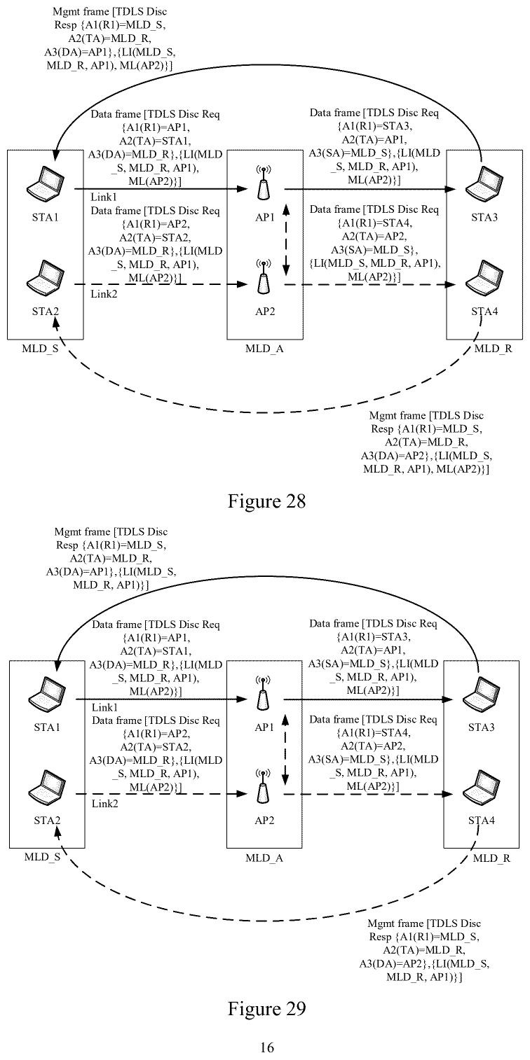

FIG. 28 illustrates an example of using option 4 to discover TDLS direct link for multiple links. STA1 and STA2 are two non-AP STAs affiliated with MLD_S. AP1 and AP2 are two APs affiliated with MLD_A. STA3 and STA4 are two non-AP STAs affiliated with MLD_R. STA1 and STA3 are associated with AP1 on link1. STA2 and STA4 are associated with AP2 on link2. As shown in FIG. 28, either STA1 or STA2 transmits a data frame carrying TDLS Discovery request (TDLS Disc Req as shown in FIG. 28) to AP1 or AP2, respectively. The TDLS Disc Req carries the information that it intends to discover TDLS direct links on link1 and link2. In the link identification element directly under TDLS discovery request action field, the BSSID field in the link identifier is set to AP1 to indicate that the MLD_S intends to discover the TDLS direct link with MLD_R on link1. In the multi-link element, the BSSID field of the link identifier element (or the BSSID field) as shown in FIG. 27 is set to AP2 to indicate that the MLD_S also intends to discover the TDLS direct link with MLD_R on link2. After MLD_A receives the TDLS Disc Req, it forwards the TDLS Disc Req to STA3 or STA4 over link1 or link2, respectively. Then, either STA3 or STA4 respond to a management frame carrying TDLS Discovery response (TDLS Disc Resp as shown in FIG. 28). The TDLS Disc Resp carries the information of possible TDLS direct links on link1 and link2. In the link identification element directly under TDLS discovery response frame action field, the BSSID field in the link identifier is set to AP1 to indicate the possible TDLS direct link with MLD_R on link1. In the multi-link element, the BSSID field of the link identifier element (or the BSSID field) as shown in FIG. 27 is set to AP2 to indicate the possible TDLS direct link with MLD_R on link2.

FIG. 29 illustrates a similar example of using option 4 to discover TDLS direct link for multiple links. STA1 and STA2 are two non-AP STAs affiliated with MLD_S. AP1 and AP2 are two APs affiliated with MLD_A. STA3 and STA4 are two non-AP STAs affiliated with MLD_R. STA1 and STA3 are associated with AP1 on link1. STA2 and STA4 are associated with AP2 on link2. As shown in FIG. 29, either STA1 or STA2 transmits a data frame carrying TDLS Discovery request (TDLS Disc Req as shown in FIG. 29) to AP1 or AP2, respectively. The TDLS Disc Req carries the information that it intends to discover TDLS direct links on link1 and link2. In the link identification element directly under TDLS discovery request action field, the BSSID field in the link identifier is set to AP1 to indicate that the MLD_S intends to discover the TDLS direct link with MLD_R on link1. In the multi-link element, the BSSID field of the link identifier element (or the BSSID field) as shown in FIG. 27 is set to AP2 to indicate that the MLD_S also intends to discover the TDLS direct link with MLD_R on link2. After MLD_A receives the TDLS Disc Req, it forwards the TDLS Disc Req to STA3 or STA4 over link1 or link2, respectively. Then, either STA3 or STA4 respond to a management frame carrying TDLS Discovery response (TDLS Disc Resp as shown in FIG. 29). This time, the TDLS Disc Resp carries the information of possible TDLS direct links on link1 only. In the link identification element directly under TDLS discovery response frame action field, the BSSID field in the link identifier is set to AP1 to indicate the possible TDLS direct link with MLD_R on link1. There is no multi-link element.

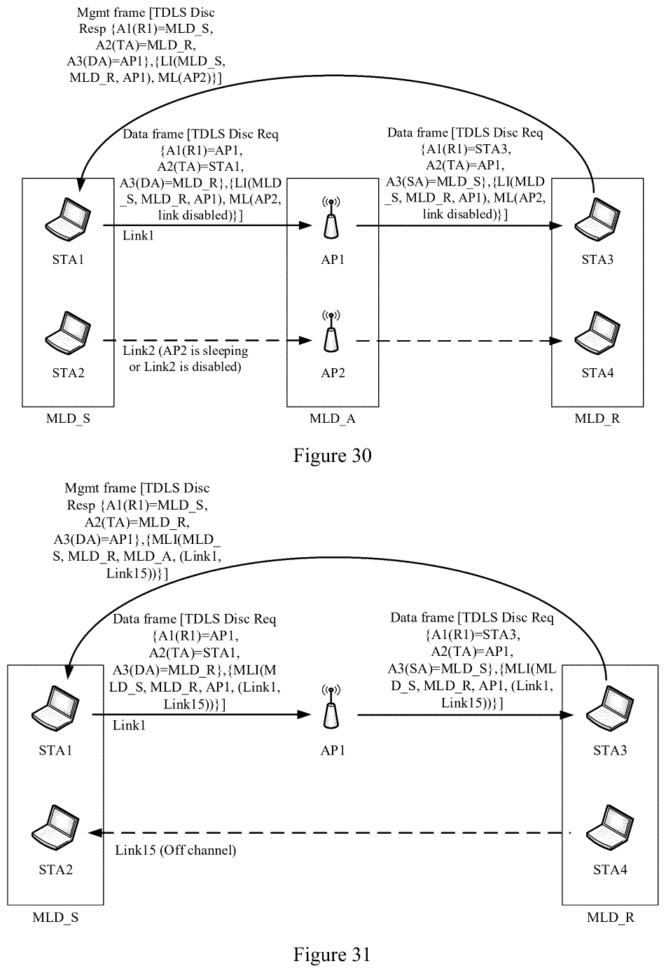

FIG. 30 illustrates an example of using option 4 to discover TDLS direct link for multiple links. Compared with the example shown in FIG. 28, link2 is disabled or AP1 (or STA2 or STA4) is in sleeping mode. STA1 and STA2 are two non-AP STAs affiliated with MLD_S. AP1 and AP2 are two APs affiliated with MLD_A. STA3 and STA4 are two non-AP STAs affiliated with MLD_R. STA1 and STA3 are associated with AP1 on link1. STA2 and STA4 are associated with AP2 on link2. As shown in FIG. 30, only STA1 is able to transmit a data frame carrying TDLS Discovery request (TDLS Disc Req as shown in FIG. 30) to AP1. The TDLS Disc Req carries the information that it intends to discover TDLS direct links on link1 and link2. In the link identification element directly under TDLS discovery request action field, the BSSID field in the link identifier is set to AP1 to indicate that the MLD_S intends to discover the TDLS direct link with MLD_R on link1. In the multi-link element, the BSSID field of the link identifier element (or the BSSID field) as shown in FIG. 27 is set to AP2 to indicate that the MLD_S also intends to discover the TDLS direct link with MLD_R on link2. However, it also indicates that link2 is disabled and the TDLS response frame should not be transmitted over link2. After MLD_A receives the TDLS Disc Req, it forwards the TDLS Disc Req to STA3 over link1. Then, STA3 responds to a management frame carrying TDLS Discovery response (TDLS Disc Resp as shown in FIG. 30). The TDLS Disc Resp carries the information of possible TDLS direct links on link1 and link2. In the link identification element directly under TDLS discovery response frame action field, the BSSID field in the link identifier is set to AP1 to indicate the possible TDLS direct link with MLD_R on link1. In the multi-link element, the BSSID field of the link identifier element (or the BSSID field) as shown in FIG. 27 is set to AP2 to indicate the possible TDLS direct link with MLD_R on link2.

FIG. 31 illustrates an example of using option 4 to discover TDLS direct link for multiple links. Compared with the example shown in FIG. 28, STA2 and STA4 are not associated with any AP. STA1 and STA2 are two non-AP STAs affiliated with MLD_S. AP1 and AP2 are two APs affiliated with MLD_A. STA3 and STA4 are two non-AP STAs affiliated with MLD_R. STA1 and STA3 are associated with AP1 on link1. As shown in FIG. 31, only STA1 is able to transmit a data frame carrying TDLS Discovery request (TDLS Disc Req as shown in FIG. 31) to AP1. The TDLS Disc Req carries the information that it intends to discover TDLS direct links on link1 and link2. In the link identification element directly under TDLS discovery request action field, the BSSID field in the link identifier is set to AP1 to indicate that the MLD_S intends to discover the TDLS direct link with MLD_R on link1. In the multi-link element, the BSSID field of the link identifier element (or the BSSID field) as shown in FIG. 27 is set to wildcard to indicate that the MLD_S also intends to discover the TDLS direct link with MLD_R on off-channel link. Since it is off-channel link, the TDLS response frame should not be transmitted over link2. After MLD_A receives the TDLS Disc Req, it forwards the TDLS Disc Req to STA3 over link1.

Then, STA3 responds to a management frame carrying TDLS Discovery response (TDLS Disc Resp as shown in FIG. 31). The TDLS Disc Resp carries the information of possible TDLS direct links on link1 and off-channel link. In the link identification element directly under TDLS discovery response frame action field, the BSSID field in the link identifier is set to AP1 to indicate the possible TDLS direct link with MLD_R on link1. In the multi-link element, the BSSID field of the link identifier element (or the BSSID field) as shown in FIG. 27 is set to wildcard to indicate the possible TDLS direct link with MLD_R on off-channel link.

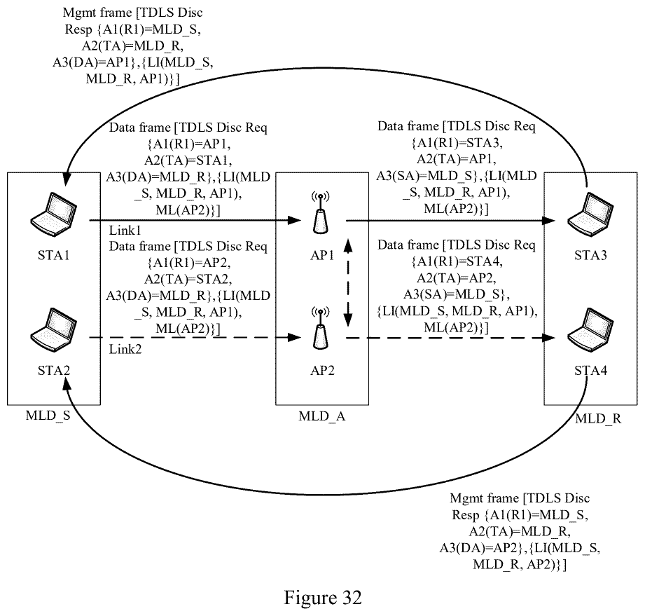

FIG. 32 illustrates an example of using option 4 to discover TDLS direct link for multiple links. Compared with the example shown in FIG. 28, STA2 and STA4 respond the TDLS discovery response frame for the TDLS direct link on its own link only. STA1 and STA2 are two non-AP STAs affiliated with MLD_S. AP1 and AP2 are two APs affiliated with MLD_A. STA3 and STA4 are two non-AP STAs affiliated with MLD_R. STA1 and STA3 are associated with AP1 on link1. STA2 and STA4 are associated with AP2 on link2. As shown in FIG. 32, cither STA1 or STA2 transmits a data frame carrying TDLS Discovery request (TDLS Disc Req as shown in FIG. 32) to AP1 or AP2, respectively. The TDLS Disc Req carries the information that it intends to discover TDLS direct links on link1 and link2. In the link identification element directly under TDLS discovery request action field, the BSSID field in the link identifier is set to AP1 to indicate that the MLD_S intends to discover the TDLS direct link with MLD_R on link1.

In the multi-link element, the BSSID field of the link identifier element (or the BSSID field) as shown in FIG. 27 is set to AP2 to indicate that the MLD_S also intends to discover the TDLS direct link with MLD_R on link2. After MLD_A receives the TDLS Disc Req, it forwards the TDLS Disc Req to STA3 or STA4 over link1 or link2, respectively. Then, either STA3 or STA4 respond to a management frame carrying TDLS Discovery response (TDLS Disc Resp as shown in FIG. 32) separately. STA3 responds to the TDLS Discovery response for the TDLS direct link on link1 only and STA4 responds the TDLS Discovery response for the TDLS direct link on link2 only.

Current spatial reuse (SR) mechanisms in IEEE 802.11 standard focuses on inter-basic service set (BSS). When there are more requirements of peer-to-peer (P2P) transmissions, it is necessary to enable intra-BSS spatial reuse for multiple P2P transmissions.

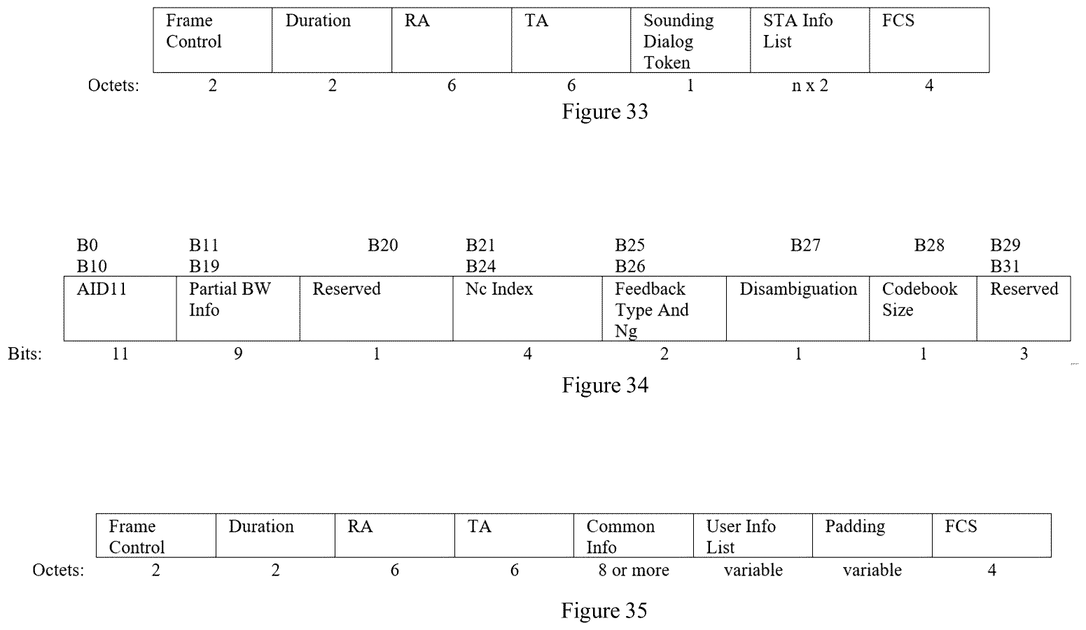

FIG. 33 exemplifies a null data packet announcement (NDPA) frame in IEEE 802.11 standard. The NDPA frame includes sounding dialog token field that supports null data packet (NDP) based sounding and calibration for wireless communication. The NDPA frame may be formatted to support wireless communication associated with extremely high throughput (EHT), 11ax, or 11az operation. An access point (AP) may indicate for multi-user (MU) or single-user (SU) sounding with NDPA. The AP may provide SU or MU sounding indication via the sounding dialog token field or a station information (STA Info) field.

FIG. 34 exemplifies a STA Info field formation in the EHT NDPA frame. The AID subfield may include 12 or 11 least significant bits (LSBs) of an association identifier (AID) to prepare for sounding feedback by processing the NDP frame following the NDPA frame, or to prepare for transmitting a beamforming report. The STA Info field further includes partial bandwidth (BW) information, a disambiguation bit, an Nc index for spatial resource information of the NDP frame and a codebook size.

FIG. 35 exemplifies a trigger frame in IEEE 802.11 standard. The trigger frame includes a frame control field to indicate a frame type, a duration field to indicate duration of occupying a channel and a corresponding acknowledgement frame, a receiving address (RA) field to identify a receive end and a transmitting address (TA) field to identify a transmit end. The frame control field, the duration field, the RA field, and TA field may be a part of a media access control (MAC) header. The trigger frame further includes a common information (Common Info) field. The Common Info field may include at least one of a processing mode bitmap subfield, a trigger type subfield, and an uplink (UL) length subfield.

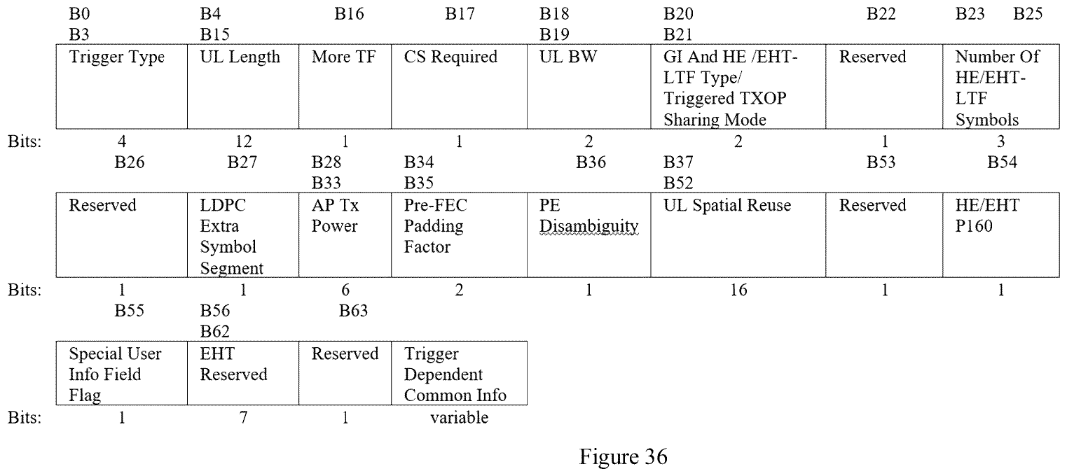

FIG. 36 exemplifies EHT variant Common Info field format. The Common Info field may be incorporated into the trigger frame. The Common/Info field includes a trigger type subfield, a UL length subfield, a more TF subfield, a channel sensing (CS) required subfield, a UL bandwidth (BW) subfield, a guard interval (GI) and high efficiency (HE)/EHT long training field (LTF) subfield, a number of HE/EHT-LTF symbols, a low density parity check (LDPC) extra symbol segment subfield, an AP transmit (Tx) power subfield, a pre-forward error correction (FEC) padding factor subfield, a packet extension (PE) disambiguity subfield, a UL spatial reuse subfield, a HE/EHT P160 subfield, a special user information (User Info) field flag subfield, a EHT reserved subfield, and a trigger dependent Common Info subfield.

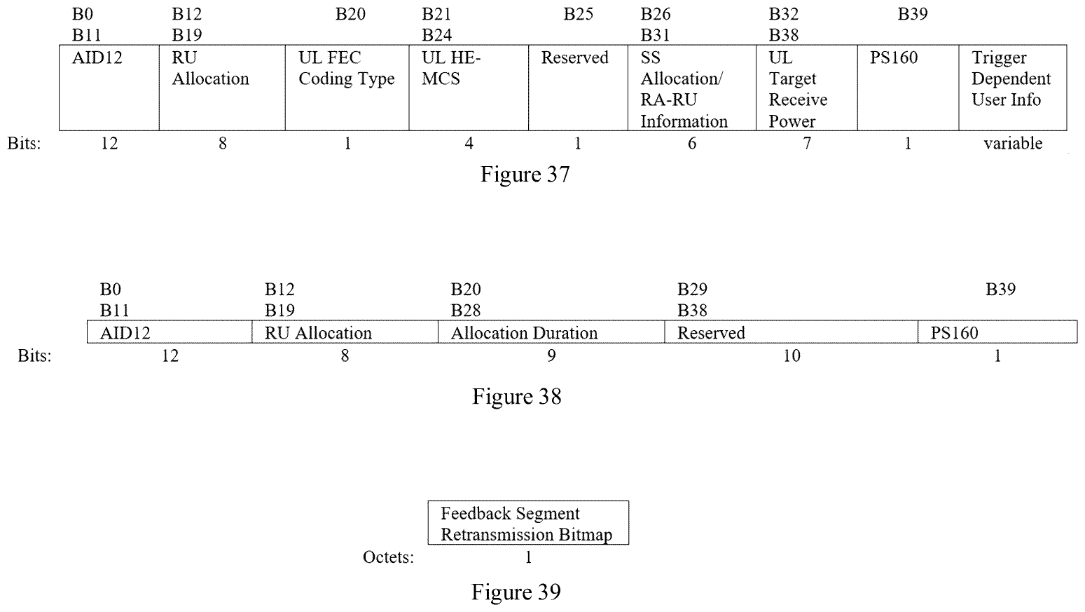

FIG. 37 exemplifies a HE variant User Info field format. The User Info field may be incorporated into the trigger frame.

FIG. 38 exemplifies an EHT variant User Info field format. The User Info field may be incorporated into the trigger frame. The User Info field includes an AID12 subfield, a resource unit (RU) allocation subfield, an allocation duration field, a reserved subfield, and a PS160 subfield.

FIG. 39 exemplifies a trigger dependent User Info subfield format in a beamforming report poll (BFRP) trigger frame. When a value of a trigger type subfield corresponds to a BFRP, the dependent User Info subfield may include a feedback segment retransmission bitmap. The trigger dependent User Info subfield may further include a spacing factor subfield, a traffic identifier (TID) aggregate limit subfield, and a reserved subfield.

EHT Compressed Beamforming/CQI frame Action field format is defined in IEEE 802.11 standard, as shown in Table 3.

TABLE 3
EHT Compressed Beamforming/Channel Quality
Indicator (CQI) Frame Action Field Format

| Order | Meaning |
|---|---|
| 1 | Category |
| 2 | EHT Action |
| 3 | EHT MIMO Control (see 9.4.1.70 (EHT MIMO Control field)) |
| 4 | EHT Compressed Beamforming Report (see 9.4.1.71 (EHT |
| | Compressed Beamforming Report field)) |
| 5 | EHT MU Exclusive Beamforming Report (see 9.4.1.72 (EHT MU |
| | Exclusive Beamforming Report field)) |
| 6 | EHT CQI Report (see 9.4.1.73 (EHT CQI Report field)) |

In a first aspect, the proposed solution enables intra-BSS spatial reuse for P2P transmissions by reusing multi-user request-to-send transmission-opportunity-sharing (MU RTS-TXS) trigger frame to enable intra-BSS spatial reuse. In a second aspect, the proposed solution includes a mechanism to measure the received signal strength indicator (RSSI) between STAs which can be used by AP to schedule spatial reuse for intra-BSS P2P transmissions. In a third aspect, the proposed solution enables P2P transmission to use a secondary channel only for transmission.

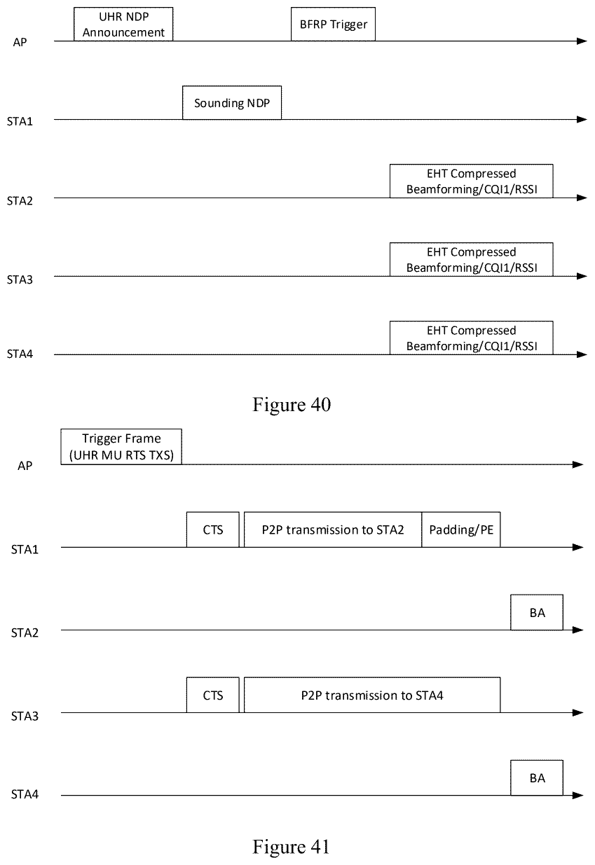

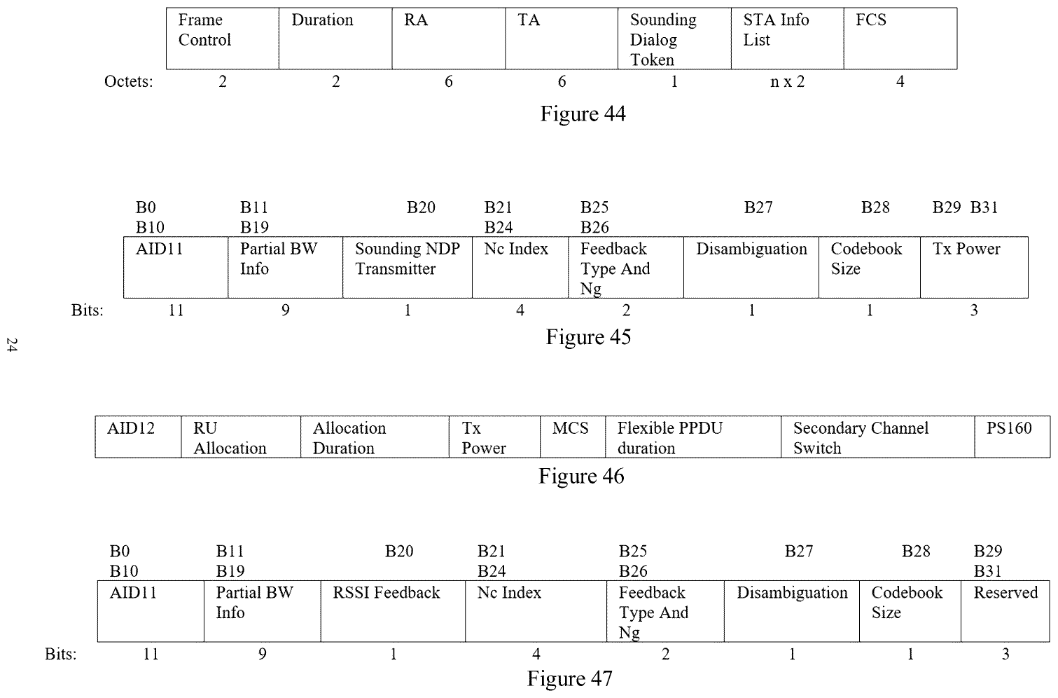

FIG. 40 illustrates a sounding procedure for P2P transmission. The proposed solution includes a sounding procedure that AP can collect path loss between the STAs involved in the intra-BSS SR P2P transmissions. Referring to FIG. 40, AP transmits an ultra-high reliability (UHR) NDP announcement which format is shown in FIG. 44. In response to a UHR NDP announcement frame, STA1 sends a sounding NDP frame to other STAs (STA 2/3/4). AP sends a BFRP trigger later to other STAs. Other STAs respond subsequently an EHT compressed beamforming, CQI or RSSI feedback to AP according to the sounding NDP they receive after the UHR NDP announcement frame.

This procedure illustrates how an AP measures the path loss between one STA (e.g., STA1) and other STAs (e.g., STA2, STA3, STA4). Then, AP obtains the path loss between STA1 and STA2, the path loss between STA1 and STA3, and the path loss between STA1 and STA4. AP may also obtain the path loss between STA1 and itself since it also receives the sounding NDP from STA1. STA1 sends the sounding NDP over the same bandwidth as the UHR NDP announcement frame. When the feedback is RSSI (or receive power), the other STAs send an action frame carrying a receive power field to report the RSSI or receive power to the AP.

FIG. 41 illustrates an example of spatial reuse for intra-BSS P2P transmissions. The proposed solution enables intra-BSS spatial reuse for P2P transmissions. In some embodiments, AP transmits a UHR MU RTS TXS which format is the same as that shown in FIG. 35 with the user info field as shown in FIG. 46. FIG. 41 shows how AP triggers spatial reuse for multiple P2P transmissions. In order to enable intra-BSS spatial reuse for P2P transmissions, AP launches a sounding procedure to obtain path loss information between the STAs. For example, AP may obtain the path loss between two stations (e.g., STA1 and STA2, STA1 and STA4, STA3 and STA4, and STA3 and STA2) to decide whether the P2P transmission from a first set of stations to a second set of stations simultaneously by limiting the transmit power and/or the modulation coding scheme (MCS) of the first set of stations so that those two P2P transmissions will not cause the transmission failure to each other. For example, the first set of stations includes STA1 and STA3 and the second set of stations includes STA2 and STA4. The P2P transmission could be from STA1 to STA2 and from STA3 to STA4. The following description exemplifies an embodiment of the proposed method:

AP transmits a UHR MU RTS TXS frame to STA1 and STA3. Inside the UHR MU RTS TXS frame, AP informs a first station (e.g., STA1) and a second station (e.g., STA3) the transmit power and/or the MCS used to transmit P2P transmission. The packet duration should be the same as the allocation duration indicated in the MU RTS TXS frame or the time that equals the allocation duration—a period of time. The period of time could be equal to the expected block acknowledgement (BA) duration which is predetermined by the network.

The first set of stations (e.g., STA1 and STA3) responds a clear-to-send (CTS) frame back to AP after they receives the UHR MU RTS TXS trigger frame. Then, STA1 and/or STA3 start to transmit P2P transmission to their own peer STAs, e.g., STA2 and STA4, respectively. The duration of the physical protocol data unit (PPDU) of the P2P transmissions of STA1 and STA3 should be the same. As shown in FIG. 41, if one P2P transmission (e.g., P2P transmission from STA1 to STA2) is shorter than the other one (e.g., P2P transmission from STA3 to STA4), then the PPDU of the first station (STA1) adds padding or packet extension (PE) to ensure the PPDU duration is the same as the other one (i.e., PPDU of P2P transmission from STA3 to STA4)

The second set of stations (e.g., STA2 and STA4) sends BA back to the first set of stations (e.g., STA1 and STA3), respectively. In some embodiments, STA2 and STA4 transmit BA at base rate. In some embodiments, AP obtains the path loss between each two stations (e.g., STA2 and STA3, and STA4 and STA1) during the sounding procedure. AP can calculate the signal to noise ratio (SNR) of received BA to ensure the BAs are received correctly.

In some embodiments, AP triggers more than two P2P transmissions as long as the interference of those P2P transmissions do not cause packet collision to each other.

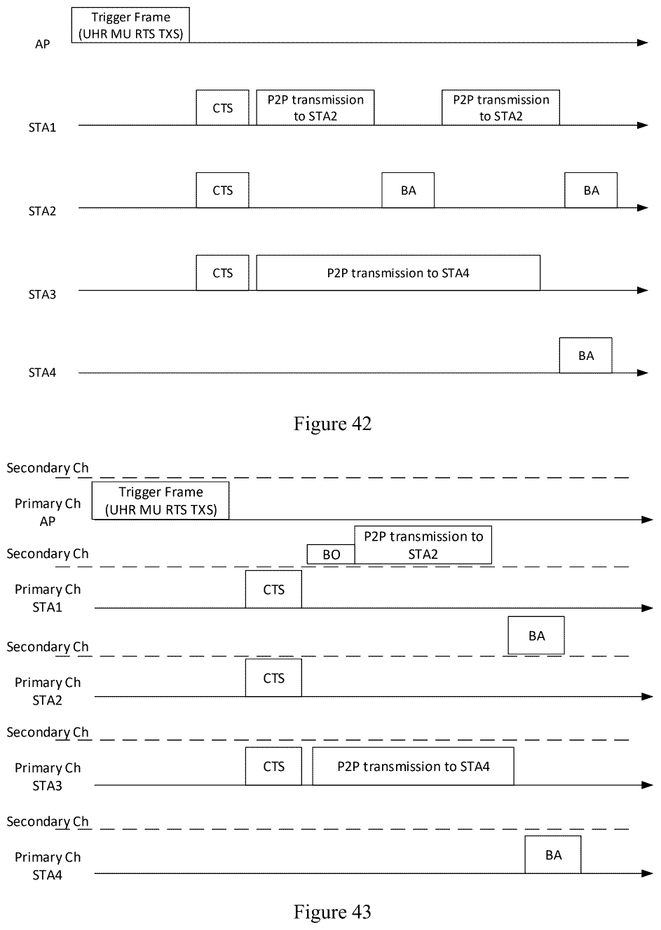

FIG. 42 illustrates another example showing how AP triggers spatial reuse for multiple P2P transmissions. AP has a flexible PPDU duration transmitted by STA1. AP is also responsible for the transmit power control of STA2. Referring to FIG. 42, AP sends a UHR MU RTS TXS trigger frame to STA1, STA2, and STA3. The UHR RTS TXS trigger frame informs STA1 to transmit P2P transmissions and the PPDU length is flexible. The trigger frame also informs STA2 to use the transmit power (and/or the MCS) indicated in the trigger frame to transmit BA after each P2P transmissions. STA1, STA2, and STA3 transmit CTS back to AP after they receive the trigger frame. Then, STA1 could transmit multiple P2P transmissions to STA2 during the allocated time. Since the trigger frame does not inform STA3 to use flexible PPDU length, it should transmit P2P transmission as shown in FIG. 41.

FIG. 43 illustrates an example of assignment of secondary channel for P2P transmission. The proposed solution allows AP to trigger P2P transmission. In some embodiments, AP only occupies the primary channel and transmits a UHR MU RTS TXS frame to multiple STAs (e.g., STA1, STA2 and STA3). For STA1 and STA2, they are two peer STAs for P2P transmission. In the trigger frame, it indicates that they should switch to secondary channel for P2P transmission during the allocation time indicated in the trigger frame. Then, the trigger frame could trigger the P2P transmission between STA3 and STA4 on the primary channel as shown in FIG. 43. B

STA1 and STA2 transmit CTS to AP when they receive the UHR MU RTS TXS frame. Since AP does not occupy the secondary channel, then STA1 contend for the channel (counting down backoff (BO) as shown in FIG. 43) before transmitting P2P transmission to STA2. Note that if STA2 wants to transmit to STA1, it should contend for the channel, too. STA1 and STA2 should switch back to primary channel when the allocation time ends or a period of time (such as the time required to switch back to the primary channel) before the allocation time ends.

FIG. 44 shows the UHR NDP Announcement frame format. All the fields could be the same as shown in FIG. 33 except that the STA Info field is shown in FIG. 45. In FIG. 45, all the fields could be the same as shown in FIG. 34 except the reserved bits are used for a sounding NDP transmitter field and a Tx power field. In the AID11 field, it indicates the receiver of the STA Info field. In the sounding NDP transmitter field, this field is set to indicate the receiver of this STA info field is responsible for transmitting sounding NDP frame. This field could be one bit field. When this field is set to “1”, then the receiver transmits sounding NDP frame. Partial BW Info field may be reserved or indicate the BW information that the receiver of the STA Info field can be used to transmit sounding NDP frame. Nc Index is set to the number of columns in a compressed beamforming feedback matrix−1 (Nc−1) to indicate the number of columns in a compressed beamforming feedback matrix. The receiver of the STA Info field should transmit the sounding NDP according to this field. The Feedback Type And Ng field, the Disambiguation field, the Codebook Size field may be reserved. The Tx Power field is set to indicate the transmit power that the receiver of the STA Info field should use to transmit the sounding NDP frame. Otherwise, the sounding NDP transmitter field is set to “0” and the STA Info field could be the same as shown in FIG. 34. The receiver of the STA Info field regards the STA Info field and takes actions the same as shown in FIG. 34. The Tx Power field can be reserved.

FIG. 46 shows the UHR variant User Info field format in the UHR MU-RTS TXS Trigger frame. In the Tx Power field, this field is set to indicate the receiver STA should set transmit power as indicated in this field to transmit PPDUs during the allocation duration. In the MCS field, this field is set to indicate the receiver STA uses the same MCS as indicated in this field (or the MCS not greater than the MCS as indicated in this field) to transmit PPDUs during the allocation duration. In the secondary channel switch field, this field is set to indicate that the receiver STA could switch to a secondary channel as indicated in RU allocation for operation during the allocation duration. The allocation duration field could be set to zero to indicate that the receiver STA should use the transmit power (and/or MCS) to transmit solicited PPDU until the current TXOP ends, or it receives any PPDU from AP. Other fields could be the same as shown in FIG. 38.

FIG. 47 shows STA Info field format in an EHT NDP Announcement frame. In the RSSI Feedback field, this field is set to “1” to indicate that the receiver STAs of the EHT NDP announcement frame should respond RSSI of the sounding NDP frame they receive during the sounding procedure. Otherwise, this field is set to “0” and the receiver STAs of the EHT NDP announcement frame do not respond RSSI of the sounding NDP frame they receive during the sounding procedure.

The embodiment of the present application further provides a computer readable storage medium for storing a computer program. The computer readable storage medium enables a computer to execute corresponding processes implemented in each of the methods of the embodiments of the present application. For brevity, details will not be described herein again.

The embodiment of the present application further provides a computer program product including computer program instructions. The computer program product enables a computer to execute corresponding processes implemented in each of the methods of the embodiments of the present application. For brevity, details will not be described herein again.

The embodiment of the present application further provides a computer program. The computer program enables a computer to execute corresponding processes implemented in each of the methods of the embodiments of the present application. For brevity, details will not be described herein again.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

It should be understood that any embodiments disclosed herein as being “non-transitory” do not exclude any physical storage medium, but rather exclude only the interpretation that the medium can be construed as a transitory propagating signal.

The elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘including’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Above all, while the preferred embodiments of the present application have been illustrated and described in detail, various modifications and alterations can be made by persons of ordinary skill in the art. The embodiment of the present application is therefore described in an illustrative but not restrictive sense. It is intended that the present application should not be limited to the particular forms as illustrated, and that all modifications and alterations which maintain the spirit and realm of the present application are within the scope as defined in the appended claims.

What is claimed is:

1. A method of wireless communication of a first non-access point (AP) station (STA), comprising:
establishing, by at least one processor, a communication link with an AP;
establishing, by the at least one processor, tunneled direct link setup (TDLS) link with a second non-AP STA;
performing, by the at least one processor, peer-to-peer communication with the second non-AP STA during the TDLS link; and
in response to at least one communication condition meeting a first condition, communicating, by the at least one processor, with the second non-AP STA via the AP using the communication link.

2. The method of claim 1, further comprising:
in response to the at least one communication condition meeting a second condition, switching back to the TDLS link from the communication and using the TDLS link to communicate with the second non-AP STA.

3. The method of claim 1, further comprising:
receiving a block acknowledgment (BA) frame from the second non-AP STA via the AP using the communication link after one or more data frames associated with the BA frame are received by the second non-AP STA.

4. The method of claim 1, further comprising:
retransmitting a frame via the AP using the communication link, wherein a total number of retransmissions of the frame via the TDLS link and the communication link is limited by a retry count.

5. The method of claim 1, further comprising:
transmitting a transmission-opportunity-sharing (RTX) frame to the AP to share transmission opportunity (TXOP) with the AP, during which the AP forwards a data frame from the first non-AP STA to the second non-AP STA and/or forwards a BA frame associate with the data frame from the second non-AP STA to the first non-AP STA.

6. The method of claim 1, further comprising:
transmitting to the AP a data frame with an indication of TXOP sharing with the AP, during the shared TXOP, the AP forwards the data frame from the first non-AP STA to the second non-AP STA and/or forwards a BA frame associate with the data frame from the second non-AP STA to the first non-AP STA.

7. The method of claim 1, further comprising:
transmitting a TDLS discovery request to the second non-AP STA via the AP, wherein the TDLS discovery request carries information of discovering TDLS direct links on a first link between the first non-AP STA and the second non-AP STA, and a second link between a third non-AP STA and a fourth non-AP STA; and
receiving, on the first link from the second non-AP STA, a TDLS discovery response in response to the TDLS discovery request, wherein the TDLS discovery response carries information of the TDLS direct links on the first link and the second link.

8. The method of claim 7, wherein the TDLS discovery request carries information that a link is disabled or a non-AP STA is in sleeping mode to indicate that the TDLS discovery response should not be transmitted over the link or to the non-AP STA in the sleeping mode.

9. The method of claim 1, further comprising:
receiving a trigger frame used to enable intra-basic service set (BSS) spatial reuse for peer-to-peer (P2P) transmission, wherein transmit power and packet duration for the P2P transmission are indicated in the trigger frame; and
transmitting the P2P transmission on a link in response to the trigger frame, wherein the P2P transmission on the link and another P2P transmission on another link are allowed to be transmitted in the packet duration.

10. The method of claim 9, wherein in a case that the trigger frame indicates multiple P2P transmissions should be transmitted on the link to a target non-AP STA, the multiple P2P transmissions on the link and the another P2P transmission on the another link are allowed to be transmitted in the packet duration.

11. A method of wireless communication of a first node, comprising:
establishing, by at least one processor, a communication session with a second node while the first node operates as a first-node type;
announcing, by the at least one processor, a transition of the first node from the first-node type to a second node-type to the second node; and
transitioning, by the at least one processor, from the first-node type to the second-node type.

12. The method of claim 11, wherein the communication session is tunneled direct link setup (TDLS) session.

13. The method of claim 12, further comprising:
maintaining the communication session with the second node once the first node transitions to the second node-type.

14. The method of claim 12, further comprising:
performing a procedure to associate or reassociate with the second node for data transmission once the first node transitions to the second node-type, wherein the procedure to associate or reassociate with the second node is performed after switching time during which the first node transitions to the second node-type.

15. The method of claim 12, wherein:
the first-node type is a peer station (STA), and
the second-node type is a soft access point (AP).

16. The method of claim 11, wherein the communication session is a link session with soft AP.

17. The method of claim 16, further comprising:
establishing another communication session with a third node once the first node transitions from the first-node type to the second-node type, wherein the another communication session is established with the third node before switching time during which the first node transitions to the second node-type.

18. The method of claim 16, further comprising:
establishing tunneled direct link setup (TDLS) session with the second node once the first node transitions from the first-node type to the second-node type, wherein the TDLS session is established with the second node after switching time during which the first node transitions to the second node-type.

19. The method of claim 16, wherein:
the first-node type is a soft access point (AP), and
the second-node type is a peer station (STA).

20. A method of wireless communication of a first node, comprising:
establishing, by at least one processor, a communication session with a second node while the second node operates as a first-node type;
receiving, by the at least one processor, an announcement of a transition of the second node from the first-node type to a second-node type from the second node; and
keeping, by the at least one processor, the communication session with the second node or establishing, by the at least one processor, another communication session with the second node after the announcement is received.
